(19) United States
(12) Patent Application Publication
(10) Pub. No.: US 2002/0032856 A1
(43) Pub. Date: Mar. 14, 2002

(54) Electronic contents proving method and system, and storage medium for storing program therefor

(75) Inventors: Tetsuya Noguchi, Yamato-shi (JP); Teruo Koyanagi, Yamato-shi (JP); Hisashi Kashima, Yamato-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/818,802

(22) Filed: Mar. 27, 2001

(30) Foreign Application Priority Data
Mar. 27, 2000 (JP) 2000-087634

(51) Int. Cl. H04L 9/00; G06F 17/60

(52) U.S. Cl. 713/156; 705/76

(57) ABSTRACT

The fact that electronic content on a network has been opened for perusal by the public is proven, and the probative force required to demonstrate the openness or the lack of alteration of electronic content can be increased. Upon the receipt of a service request from a user who desires to prove that electronic content has been opened for perusal by the public, a service provider preferably selects, from a registered member group, multiple witnesses or certificate generators, and issues certificate generation requests to the selected witnesses or certificate generators. Electronic signatures of the witnesses or the certificate generators are provided for the certificates, to each of which the service provider adds his or her electronic signature, and the certificates are transmitted to the user.

### FIELD OF THE INVENTION

The present invention relates to a method and a system for proving electronic content and a storage medium for storing a program therefor, and particularly to a technique that can effectively prove openness of subject electronic content for perusal and subject electronic content has not been altered.

### BACKGROUND ART

It is generally considered common knowledge that information concerning ideologies, technical ideas, such as inventions, and other documents and drawings are publicly disclosed by being issued as printed matter and/or by being included in publications wherein characters and graphic illustrations are printed on paper media. Such printed matter is usually accepted as written proof, and is also, once authenticity has been established, admissible as documentary evidence, as evidence for a contract freely entered into by two or more parties, or as evidence for administrative procedures such as probative matter detailing lack of novelty of invention, as set forth in Japanese Patent Law section 29, subsection 1, paragraph 3 and section 30., etc. The availability of printed matter or of verifiable evidence that information has been published can be easily attested by providing the printed matter itself and publication dates. And proof that there has been no alteration of meaning can be demonstrated by providing examples showing that the content of printed matter has not been changed.

In accordance with recent developments in techniques employed on the Internet, opportunities have increased whereby information (content) that conventionally is disclosed using printed matter is laid open for perusal by the public using the Internet. Since such electronic content is thus disclosed as it would be included in printed matter, interested parties desire to utilize as evidence, as is described above, content opened for perusal in this fashion.

An electronic notary system, such as “www.surety.com”, is well known that can be used to affirm the presence of electronic contents. The electronic notary system converts the electronic contents into hash code, and announces the hash code in a newspaper to notify unspecified third parties of the existence of the electronic content, and establishes the fact that the electronic content thereby made available. Thus, facts written as electronic content can be proved, and when, for example, a copyright is included in the electronic contents, the inclusion of the copyright can be attested.

However, when electronic content is to be used as evidence, as is described above, this, unlike the use of printed matter for a like purpose, produces a unique problem, i.e., questions as to the probative force of electronic content have arisen. Since a publisher (a homepage creator) independently uploads electronic content to a homepage, it would be difficult to prove the publication of such content and to furnish a publication date without obtaining certification provided by a third party, such as a notary public. Further, since the operation of a homepage is generally a voluntary activity, a homepage operator can freely alter content, so that the probative force as to non-alteration of the content is weakened without the provision of third party authentication. While means for proving the existence of electronic content is available, as is described above, probative force equivalent to that attributable to printed matter can not be acquired merely by establishing the fact that electronic content is available. For example, in order to confirm that a technical idea for electronic content (an invention) is, as stated in Japanese Patent Law section 29, subsection 1, paragraph 3, “inventions which have been described in a publication distributed in Japan or elsewhere or inventions which became available to the general public through telecommunication lines in such places prior to the filing of the patent application”, according to the “Operational Guidelines on Treatment of Technical information disclosed on the Internet as Prior Art” provided by the Japanese Patent Office, the following is required: “information should be available to the public”, i.e., information should be so distributed and stored that it can be obtained and perused by any and all unspecified persons, and that electronic technical information cited when filing for a patent application should be written exactly as previously described. However, the conventional technique can not be used to prove openness for perusal (availability to the public) nor that at the time of the filing of the patent application no content alteration has been made.

Openness for perusal (availability to the public) and that no electronic content has been altered are to be proved not only for claiming as prior art for the Patent Law. However, using the conventional technique, only the fact that specific electronic content was available on a specific date can be proved; it is difficult to prove openness for perusal and that the content was not altered (completeness and legality).

### SUMMARY OF THE INVENTION

It is one object of the present invention to provide means for attesting to the openness for perusal of electronic contents that are present on a network.

It is another object of the present invention to provide means for attesting there has been no alteration of the electronic content that is present on a network.

It is an additional object of the present invention to provide the probative force necessary to demonstrate the openness for perusal and lack of alteration of the electronic content.

An overview of the present invention will now be presented. Specifically, according to the invention, for a user who desires to prove the openness for perusal of electronic contents, a plurality of witnesses or certificate generators are selected from proposed witnesses registered in advance, and a certificate of having obtained the electronic content is issued by the selected witnesses or certificate generators, so that the openness for perusal of the electronic contents can be proved. The witnesses or the certificate generators can be selected at random from a group of registered witnesses (including certificate generators). In this case, it is preferable that a large group be registered and be prepared to guarantee randomness. In this invention, a proxy server possessing a certificate generation function can be employed as a certificate generator.

According to the present invention, witnesses or certificate generators (third parties) that are unrelated not only to a user but also to a service provider issue certificates. Thus, since the certificates are issued by witnesses that is not related to a user they acquire a higher probative force. In addition, according to the present invention, many certificates can be collected via a computer network, such as the Internet, and the probative force increases as the number of witnesses (certificates) grows.

### BRIEF DESCRIPTION OF THE DRAWINGS

FIG. 1 is a conceptual diagram for explaining an example proving system according to a first embodiment of the present invention.

FIG. 2 is a block diagram showing an example service provider and an example certificate generator for the system according to the first embodiment.

FIG. 3 is a block diagram showing an example certificate request receiver and an example certification manager.

FIG. 4 is a block diagram showing an example certificate generation manager, an example certification generation processor and an example electronic signature generator.

FIG. 5 is a block diagram showing another example certificate generation manager, another example certification generation processor and another electronic signature generator.

FIG. 6 is a flowchart showing the general processing performed for the method of this invention.

FIG. 7 is a diagram showing a screen for an example usage request dialogue when a user issues a service request.

FIG. 8 is a detailed flowchart showing a user verification step.

FIG. 9 is a detailed flowchart showing a user's request analyzation step.

FIG. 10 is a detailed flowchart showing a registered member selection step.

FIG. 11 is a detailed flowchart showing a certification process.

FIG. 12 is a diagram showing a screen for an example intent confirmation dialogue used for a witness process.

FIG. 13A is a block diagram showing a system for use of an external clock for time synchronization.

FIG. 13B is a flowchart showing a time synchronization method.

FIG. 14A is a block diagram showing a system for use of an internal clock for time synchronization.

FIG. 14B is a flowchart showing a time synchronization method.

FIG. 15 is a detailed flowchart showing a certificate generation step.

FIG. 16 is a diagram showing a screen for a certificate generation dialogue before an electronic signature is provided.

FIG. 17 is a detailed flowchart showing an electronic signature step.

FIG. 18 is a detailed flowchart showing a certificate acceptance step.

FIG. 19 is a diagram showing a screen for the final production of an example certificate by a service provider.

FIG. 20 is a diagram showing a screen for the final production of another example certificate by a service provider.

FIG. 21 is a detailed flowchart showing a certificate dispatching step.

FIG. 22A is a block diagram showing a witness registration system.

FIG. 22B is a flowchart showing a witness registration method.

FIG. 23 is a conceptual diagram for explaining an example proving system according to a second embodiment of the present invention.

FIG. 24 is a block diagram showing an example service provider and an example certificate generator for the system according to the second embodiment.

FIG. 25 is a block diagram showing an example certificate generation manager and an example certification generation processor.

FIG. 26 is a conceptual diagram for explaining an additional example proving system according to the present invention.

FIG. 27 is a conceptual diagram for explaining a further example proving system according to the present invention.

### Description of the Symbols

10: Service provider

11: User

12: Registered member group

12a: Witness

12a: Certificate generator

13: Content transmitter

14: Electronic content

21: Certificate request receiver

22: Certificate transmitter

23: Certification manager

23a: Time synchronization unit

24: Communication unit

25: Registered member selector

26: Registered member database

27: Clock

28: Electronic content acquisition unit

29: Communication unit

30: Certificate generation manager

31: Electronic content acquisition unit

32: Clock (internal clock)

33: Certification generation processor

34: Electronic signature generator

36: Public key authentication server

40: Registered member database

41: Witness registration manager

42: Communication unit

43: Communication unit

44: Witness registration unit

81: Button

211: User address

212: Content address

213: Witness condition

214: Certificate period

215: Certificate of accuracy

231: User verification unit

232: User request analyzation unit

233: Usage history file

234: Certificate dispatching unit

235: Certificate acceptance unit

236: Witness process requesting unit

237: Time manager

302: Electronic content

303: Time

331: Data set

332: Certificate

341: Hash function unit

342: Hash code

343: Secret key encryption means

344: Encrypted hash code

345: Public key

346: Encrypted content address

347: Encrypted electronic content

348: Encryption time

800: Dialogue

800: Input dialogue

801: Input field

802 to 809: Input field

810: OK button

811: Cancel button

820: Dialogue

821: OK button

822: Cancel button

830: Dialogue box

831: Field

832: Field

834: OK button

835: Cancel button

840: Frame

841: File

842: Field

843: Field

850: Frame

851: Field

852 to 855: Field

856: Field

900: Notary service provider (electronic notary service)

901: Witness profile

902: Data

903: Certificate

### PREFERRED EMBODIMENTS

The preferred embodiments of the present invention will now be described in detail. It should be noted, however, that the present invention should not be construed as being limited to the embodiments included in the following explanation, but that additionally it can be implemented by various other embodiments. It should also be noted that throughout the following explanation the same reference numerals are used for corresponding or identical components.

In the following embodiments, methods and systems will mainly be described. However, as will be apparent to one having ordinary skill in the art, the present invention can be carried out not only by a method and a system, but also by a storage medium on which computer executable program code is stored. Therefore, the present invention can be provided as hardware or as software, or as a combination of the two. The storage medium used for storing program code can be an arbitrary computer-readable storage medium, such as a hard disk, a CD-ROM, an optical storage device, or a magneto-optical disk.

For the invention, an applicable computer system comprises a central processing unit (CPU), a main memory (random access memory (RAM)) and nonvolatile memory (read only memory (ROM)), all of which are interconnected by a bus. A co-processor, an image accelerator, a cache memory and an input/output control unit (I/O) are also connected to the bus. And since it is natural that hardware resources with which a computer system is generally equipped should be included, an external storage device, a data input device, a display device and a communication controller may be connected to the bus via an appropriate interface. The external storage device can be a hard disk device, but is not thus limited, and can include a semiconductor storage device, such as a magneto-optical storage device, an optical storage device or a flash memory. A read only storage device, such as a CD-ROM, can also serve as an external storage device, if it is employed only for reading data or a program. Further, the data input device can be, for example, a keyboard or a pointing device, such as a mouse, or can even be a voice input device. And a CRT, a liquid crystal display device or a plasma display device can be employed as a display device. Finally, the computer system in the embodiments can be a personal computer, a workstation, a mainframe computer or some other type of programmable machine.

In the embodiments, for communication between computer systems, mainly the Internet is employed, but a LAN or a WAN to which a plurality of computer systems are connected may be employed instead, and a communication line used for this connection may be either a special network line or a public network line. Further, although in the embodiments multiple computer systems are employed, the present invention may be implemented by a single computer.

The program used by one computer system may be recorded in another computer. That is, a remote computer can perform distributed processing for one part of the program used by the computer system. It should be noted that the DNS or the URL can be referred to the program that is stored in another computer system.

When mention is made of the accessing of the Internet, as it is in this specification, the remark applies both to intranets and to extranets. The term “computer network” includes both a publicly accessible computer network and a privately accessible computer network.

### First Embodiment

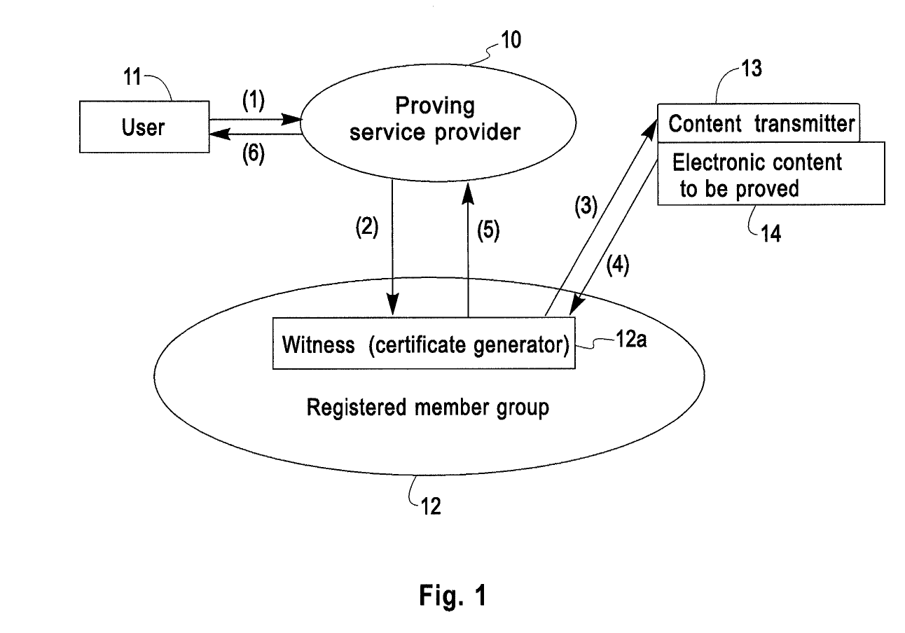

FIG. 1 is a conceptual diagram for explaining an example proof system according to one embodiment of the present invention. The system in this embodiment includes a service provider 10, a user 11, a registered member group 12, which comprises a group of witnesses or certificate generators 12a, a content transmitter 13, and electronic content 14. The above described general computer system, which is connected to the Internet, is employed as the service provider 10, the user 11, a witness or a certificate generator 12a, and the content transmitter 13. HTTP (Hypertext Transfer Protocol), for example, is employed for the transmission of data between the computer systems, and data written in HTML (Hypertext Markup Language) can be displayed using an appropriate browser.

The service provider 10 is means for proving that electronic content has been opened for perusal or that the electronic content has not been altered. The service provider 10 will be described in detail later.

The user 11, who accepts a service for the proving of the electronic content, employs the above described computer system to transmit a service request (client request) to the service provider 10. Upon receipt of the service request, the computer system of the service provider 10 functions as a server and prepares a document using HTML or XML (Extensible Markup Language) that it returns to the computer system of the user 11, whereat it is displayed the screen of the display device.

The witness or certificate generator 12a is a person or a computer system that issues a certificate for the electronic content upon the receipt of a proof request from the service provider 10. The witness issues a certificate by operating a computer system, the certificate generator 12a. The certificate generator 12a may not only be operated by the witness, but may itself also serve as a proxy server. When serving as a proxy server, the certificate generator 12a automatically issues a certificate, without requiring the intervention of a human. The certificate generator 12a will be described in detail later.

The content transmitter 13 is a computer system that stores electronic content 14 to be proved. The electronic content 14 can be, for example, a document file, such as a homepage that is displayed by a common browser. However, the electronic content 14 is not limited to a document file (e.g., an HTML document or an XML document) displayed by a browser, but may be a data file that can be transferred using FTP (File Transfer Protocol), data posted on a bulletin board used for PC communication service, or data in a message dispatched to a network news destination. The electronic content 14 can be any electronically recorded data; even data printed on paper can be included in the electronic content 14 classification, just so long as the data can be converted into electronic data using an image reader.

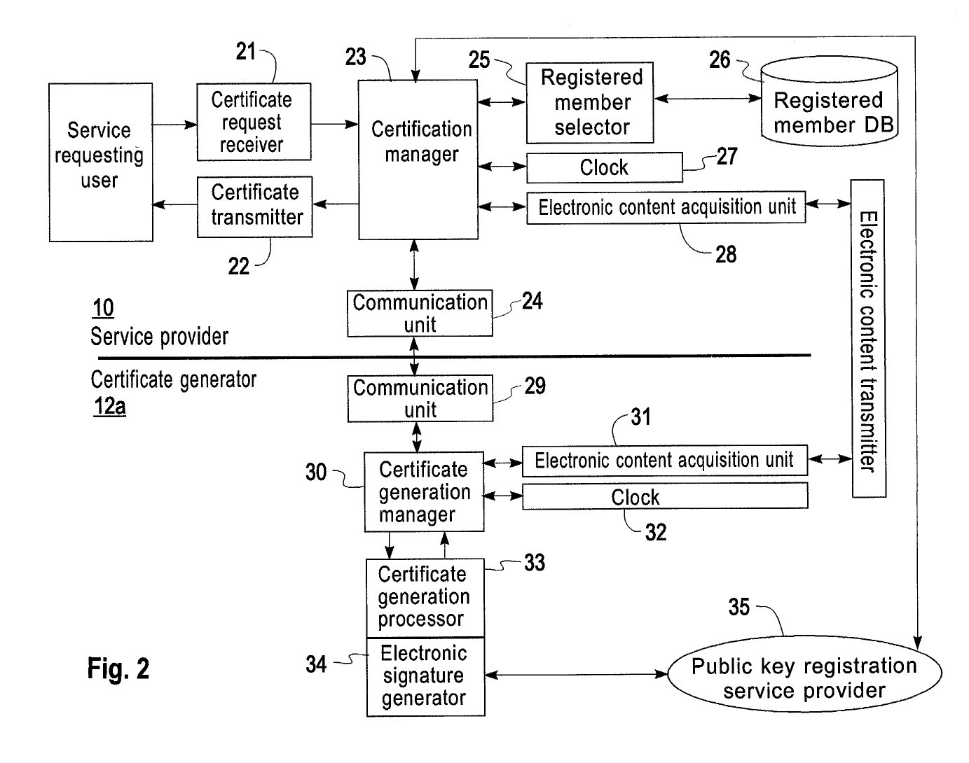

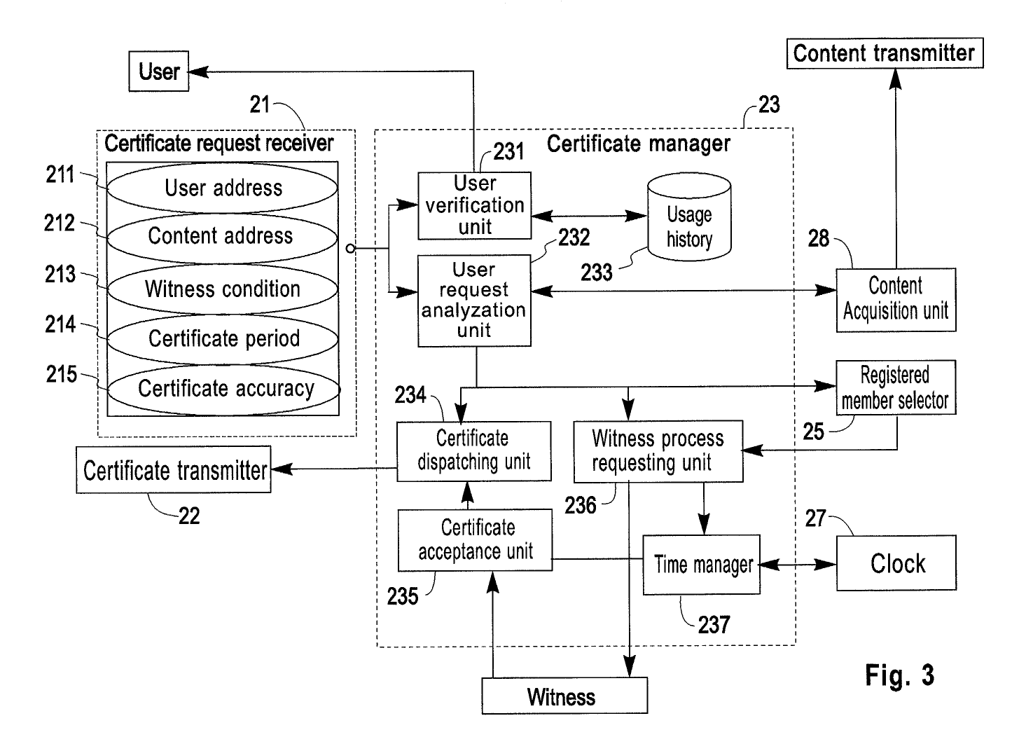

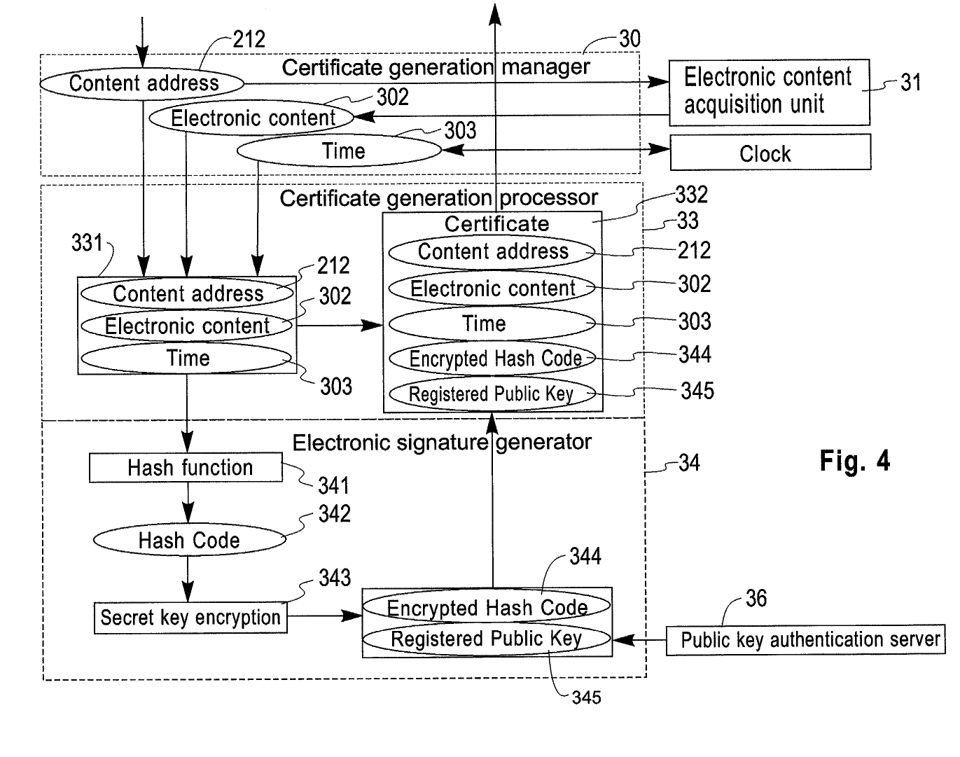

FIG. 2 is a block diagram showing examples for the service provider 10 and the certificate generator 12a of the system according to the first embodiment. FIG. 3 is a block diagram showing an example certificate request receiver and an example certification manager. FIG. 4 is a block diagram showing an example certificate generation manager, an example certification generation processor and an example electronic signature generator. As is shown in FIG. 2, the service provider 10 comprises a certificate request receiver 21, a certificate transmitter 22, a certification manager 23, a communication unit 24, a registered member selector 25, a registered member database 26, a clock 27, and an electronic content acquisition unit 28. The certificate generator 12a includes a communication unit 29, a certificate generation manager 30, an electronic content acquisition unit 31, a clock 32, and a certification generation processor 33 and an electronic signature generator 34.

The individual sections or the more detailed portions of these sections are implemented as software functions that are provided as programs for the computer system. The software functions can be obtained by using the hardware resources of the computer system.

The certificate request receiver 21 receives from the user 11 a service request that, as is shown in FIG. 3, includes a user address 211, a content address 212, a witness condition 213, a certificate period 214 and a certificate of accuracy 215.

The certificate transmitter 22 transmits the certificate that is finally prepared to the user 11. When the user 11 and the service provider 10 are interconnected via the Internet, the certificate may be transmitted as an HTML document using HTTP, or may be transmitted using FTP or as an e-mail.

The certification manager 23 manages the certification process performed by the service provider 10. As is shown in FIG. 3, the certification manager 23 includes a user verification unit 231, a user request analyzation unit 232, a usage history 233, a certificate dispatching unit 234, a certificate acceptance unit 235, a witness process requesting unit 236 and a time manager 237. The functions of the individual sections will be described in detail later during the explanation of the method of the invention.

The communication unit 24 has a control function for communicating with the certificate generator 12a, which is the computer system of a witness or which itself serves as a proxy server. A certificate request is transmitted via the communication unit 24 to the certificate generator 12a. And for communication performed via the Internet, the certificate request may be transmitted as an HTML document using HTTP, or may be transmitted using FTP or as an e-mail.

In accordance with the analyzation results obtained in response to the request by the user 11 and transmitted to the user request analyzation unit 232, the registered member selector 25 selects a required number of appropriate registered members from the registered member database 26. During this process, a determination is made as to whether humans or proxy servers should be selected as registered members, or whether the number of registered members should be limited in accordance with an area requirement. When a registered member is a human, age, gender or occupation limitations may be applied during the process to determine whether the selection of the member is appropriate. Note, however, that the conditions listed here are merely examples, and that other conditions may be added. In the registered member database 26, not only is the type of registered member (a human or a proxy server) recorded, but also the district, the age, the gender, the occupation and other necessary information, such as a certification history, are entered. Further, the registered member database 26 need not be stored in the service provider 10, but may be recorded in an external storage area identified by an address, such as a URL.

While the clock 27 is incorporated in the computer system, the clock 27 need not be internally provided for the service provide 10, and the clock of an external service provider may be referred to.

The electronic content acquisition unit 28 is used when the service provider 10 can not itself obtain at the content address 212 the electronic content that is included in the service request. The electronic content acquisition unit 28 includes a function for obtaining data based on the protocol that matches the recorded electric content. For example, if the electronic content is an HTML document, the electronic content acquisition unit 28 employs HTTP to acquire the electronic data. The electronic content obtained here is used to determine whether this content is identical to the electronic content obtained by a witness or a proxy server.

The communication unit 29 has a control function for communicating with the computer system of the service provider 10, and has the same configuration as the communication unit 24. The certificate generation manager 30, in the certificate generator 12a of the witness or the proxy server, manages the preparation of a certificate. As is shown in FIG. 4, the certificate generation manager 30 refers to the content address 212 included in the certificate request, and obtains electronic content 302 via the electronic content acquisition unit 31. The certificate generation manager 30 also obtains a time 303 from the clock 32. The electronic content acquisition unit 31 has the same configuration as the electronic content acquisition unit 28.

While the clock 32 is incorporated into the certificate generator 12a, it is not necessarily provided for the certificate generator 12a, and a clock belonging to an external service provider may be referred to.

The certification generation processor 33 prepares a certificate. The certification generation processor 33 produces the content address 212 included in the certificate request, the electronic content 302 that has been obtained and the time 303 that is obtained as a set of data 331, and transmits the data 331 to the electronic signature generator 34.

The electronic signature generator 34 includes a function for providing an electronic signature for the data set 331. The electronic signature generator 34 employs a hash function unit 341 to generate hash code 342 using the data set 331. Thereafter, inherent secret key encryption means 343 encrypts the hash code 342, and an encrypted hash code 344 is transmitted to the certification generation processor 33, along with a public key 345 registered in a public key authentication server 36.

The certification generation processor 33 adds the encrypted hash code 344 and the public key 345 to the data set 331 (including the content address 212, the electronic content 302 and the time 303) to generate a certificate 332.

Since the data set 331, which includes the electronic content 302, that generally has a large volume is converted into the hash code 342 that has a small volume, whether or not the contents are identical can be easily determined. That is, when the data are converted into hash code, a small difference between the data before conversion appears as a large change in the hash code. Thus, when multiple certificates are compared, the alteration of the content appears as a large change in the hash code.

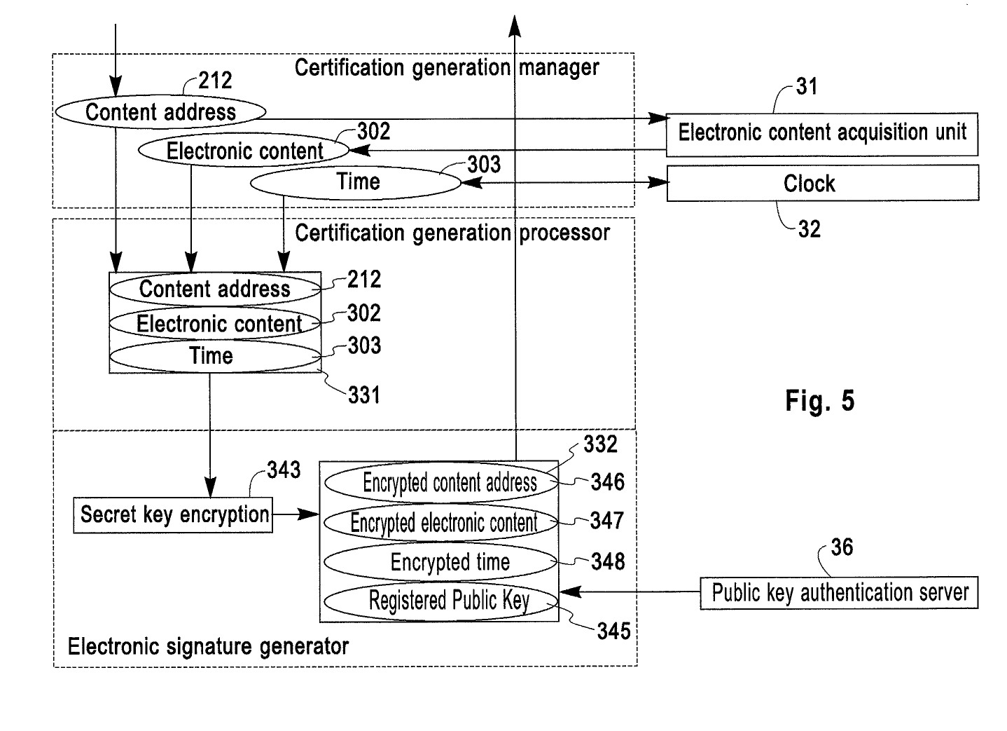

In this embodiment the hash code 342 is employed; however, another data conversion method may be employed whereby data can be uniquely represented. Further, as is shown in FIG. 5, the hash code may not be employed. In this case, to obtain the certificate 332, the set of data 331 may be encrypted using the secret key encryption means 343, and a public key 345 may be added to an encrypted content address 346, encrypted electronic content 347 and an encryption time 348.

The proving method for this invention will now be described. The overview of the proving method of this invention that follows is presented while referring to FIG. 1. The user 11 requests a service from the service provider 10 (step (1) in FIG. 1). To issue the service request, the user 11 transmits the address of the content transmitter 13 that distributes the electronic content 14 that is to be proved, and if necessary, also transmits various conditions to be applied for the selection of the witnesses.

From the registered member group 12, which consists of witnesses or certificate generators 12a that have been registered in advance, the service provider 10 selects at random witnesses or certificate generators 12a that match the conditions (step (2)). During this process, the service provider 10 employs the addresses to be proved of the selected witnesses or certificate generators 12a to request that they to prove that the content was opened for public perusal.

The witnesses or the proxy servers (the certificate generators 12a) request that the content transmitter 13 (step (3)) transmit the content to them.

If the content has already been opened for perusal, the electronic content 14 to be proved is transmitted to the witnesses or the proxy servers (the certificate generators 12a) (step (4)).

When the witnesses or certificate generators 12a have scanned the electronic content 14, they add time stamps to the electronic content 14, perform a non-variable process, such as electronic signing, that the service provider 10 is not related to, and transmit the resultant content 14 to the service provider 10 (step (5)). In this manner, the preparation and transmission of the certificates are completed.

Upon the receipt of the certificates from the witnesses or the certificate generators 12a, the service provider 10 performs a unique non-variable individual or collective process for the certificates. Subsequently, each of the resultant certificates, to which the conditions for the selection of the witness can be attached, are transmitted to the user 11.

Since for the electronic content 14 the process employed to determine no alteration has occurred is performed not only by a witness (or a proxy server), but also by the service provider 10, alteration of the certificate is extremely difficult, not only by the user 11 and a third party, but also by the service provider 10 and the witness (or the proxy server) 12a. Therefore, the validity of the certificate is increased. Further, when multiple certificates are collected and these certificates indicate that the content is identical, the existence (identity) of the content can be proved. As the number of certificates is increased, so too is the probative force.

Furthermore, when the certificates are continuously collected and when the contents of the certificates prove to be identical, the lack of alteration for the pertinent period can also be proved.

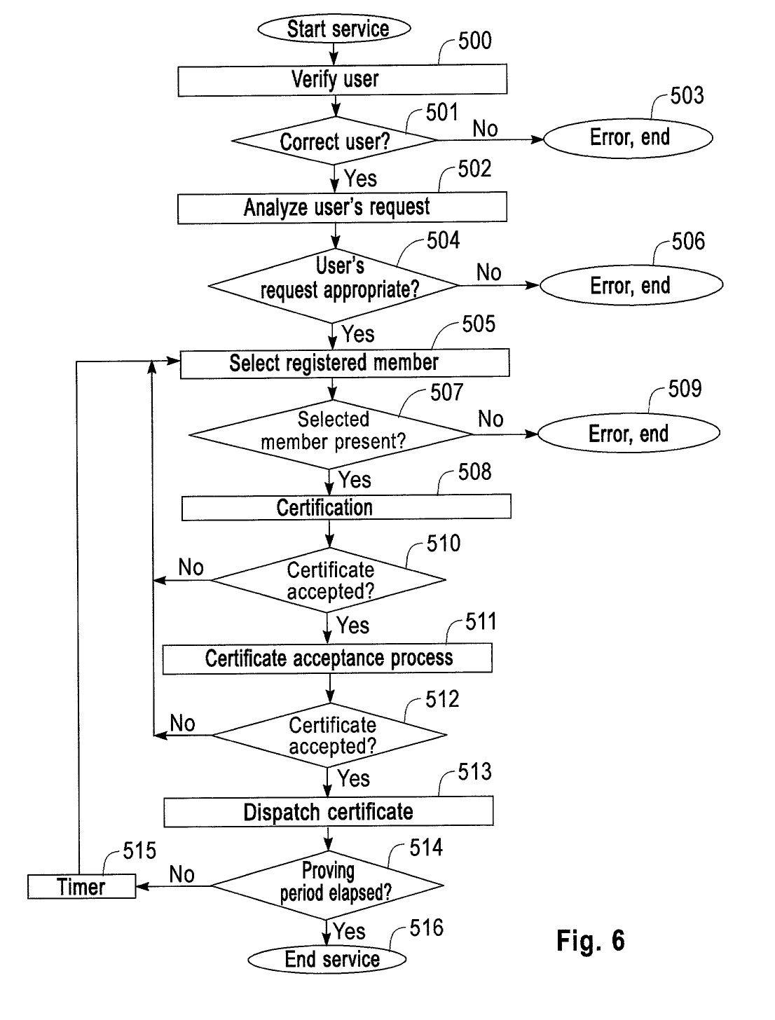

The method of this invention will now be described in detail while referring to the flowchart in FIG. 6, which shows the general processing performed using the method of the invention.

According to the method of the invention, the rendering of a service is begun upon the receipt of a service request from the user 11. First, when the server of the service provider 10 receives a service request from the user 11, the server begins a process to identify the user 11 (step 500). The user verification unit 231 in the certification manager 23 verifies the identity of the user 11 by referring to the usage history 233. A check is then performed to determine whether the user 11 is an authenticated user (step 501), and if it is determined the user 11 is an authenticated user, program control shifts to step 502. If the user 11 is not an authenticated user, an error process is performed and the processing is thereafter terminated (step 503).

Thereafter the service request from the user 11 is analyzed by the user request analyzation unit 232 in the certification manager 23 (step 502). A check is performed to determine whether the request from the user 11 is appropriate (service available) (step 504), and, if the request is appropriate, program control advances to step 505. However, if the request is not appropriate, an error process is performed and the processing is thereafter terminated (step 506).

A member is selected by the registered member selector 25 (step 505), and a check is performed to verify the selected member is a registered member (step 507). If the selected member is a registered member, program control advances to step 508. If the selected member is not a registered member, an error process is performed and the processing is thereafter terminated (step 509).

Then, the certification process is performed (step 508). The certification process consists of the dispatch of a certificate request by the witness process requesting unit 236 and a process performed by the witness upon the receipt of the certificate request.

A check is performed to determine whether a certificate has been prepared by the witness (step 510). If a certificate has been prepared, program control advances to step 511 for acceptance of the certificate. If a certificate has not been prepared, program control returns to step 505 for the selection of a new registered member.

The certificate is subjected to the certificate acceptance process (step 511). A check is thereafter performed to determine whether the certificate has been accepted (step 512). If the certificate has been accepted, program control advances to step 513 for the certificate dispatching process. If the certificate has not been accepted, program control returns to step 505 for the selection of a new registered member.

Program control then advances to step 513 for the certificate dispatching process, and a check is performed to determine whether the certification period has expired (step 514). If the certification period has not expired, while a timer 515 is referred to, program control returns to step 505 for the selection of a new registered member at a new certification time, and the certification process is repeated. When the certification period has expired, the processing for the service is terminated (step 516).

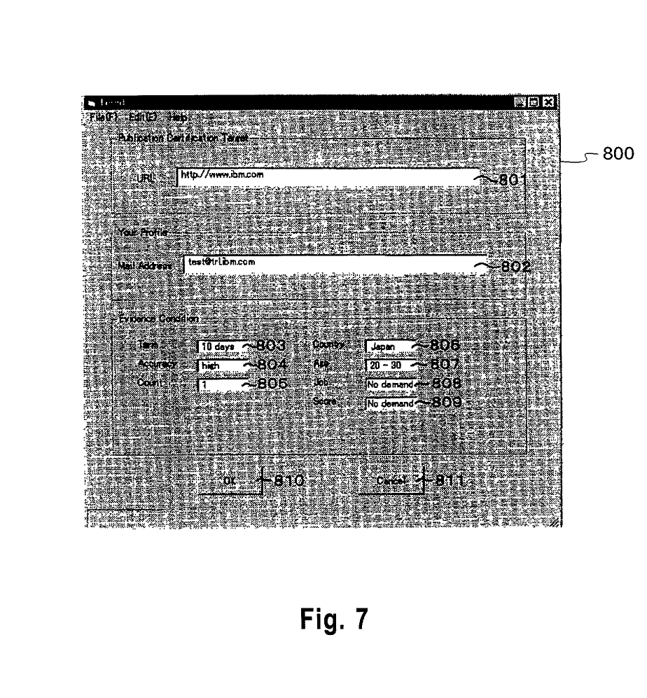

The individual steps will now be described in detail while referring to FIG. 7, wherein an example usage requesting dialogue is shown that is used when the user 11 issues a service request.

When the user 11 issues a service request to the service provider 10, the user 11 enters necessary data in a dialogue 800 and transmits the data to the service provider 10. As data to be entered, an address, for example, of the electronic content 14 to be proved is entered in an input field 801. The address is written, for example, as a URL, and in this embodiment, “http://www.ibm.com” is entered. As the profile for the user 11, a user address is written in an input field 802, and in this embodiment, an e-mail address, “test@trl.ibm.com”, is entered. As certification conditions, a period, an accuracy rating, the number of certificates, the nationality, age and occupation of the witness, and the proof history are entered in input fields 803 to 809. These conditions are merely examples, and not all of them are always required. Furthermore, other conditions may be added.

When the entry of data has been completed, to submit the data, the user 11 clicks on an “OK” button 810. Or to cancel the submission of the data, the user 11 clicks on a “Cancel” button 811.

In this example, the input dialogue 800 is shown that is provided as one part of an application program installed in the computer system of the user 11. However, a document for an input screen may be displayed by an appropriate browser.

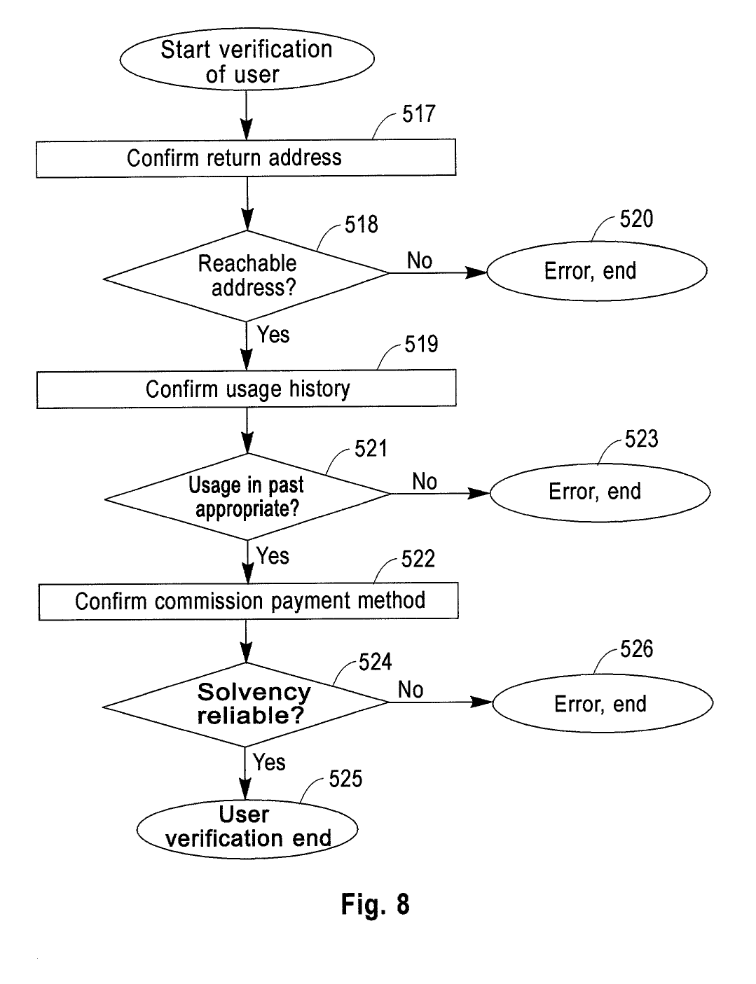

When the user 11 has clicked on the OK button 810, the data entered in the input fields are transmitted to the server of the service provider 10. Upon the receipt of these data, the server of the service provider 10 initiates a process performed to identify the user 11 (step 500). FIG. 8 is a detailed flowchart showing the user verification step.

First, the address (the return address) of the user 11 that was included in the service request (the input data) is confirmed (step 517). To acknowledge the receipt of the data and to determine whether a valid return address was submitted, an e-mail is transmitted to the return address (step 518). If the e-mail can be delivered, program control advances to step 519, and if the e-mail can not be delivered, an error process is performed and the user verification processing is thereafter terminated (step 520).

Subsequently, the usage history of the user 11 is examined (step 519). To examine the user history, the usage history file 233 is employed to determine whether usage of the user 11 in the past was is satisfactory (step 521). If the usage in the past was not satisfactory, e.g., if no payment of a fee is recorded in the history, data to that effect is stored for the user in the usage history file 233, and is employed to determine whether the current usage is appropriate. Then, if it is found that the usage in the past was illegal, an error process is performed (step 523). But if there was no past illegal usage, the current usage is permitted, and program control advances to step 522. It should be noted that transmission of a message indicating that usage was not permitted can be included in the error process.

The method employed for the payment of a commission is then examined (step 524). An arbitrary payment method can be employed, such as payment using a credit card, a transaction service provided through a network using electronic money or a ticket, or payment from an account of a user through the money transfer. A check is then performed to determine whether the user is solvent (step 524). When the user is solvent, the user verification process is terminated, and program control is shifted to the next step (step 525). When the user is not solvent, an error process is performed, and the processing is thereafter terminated (step 526).

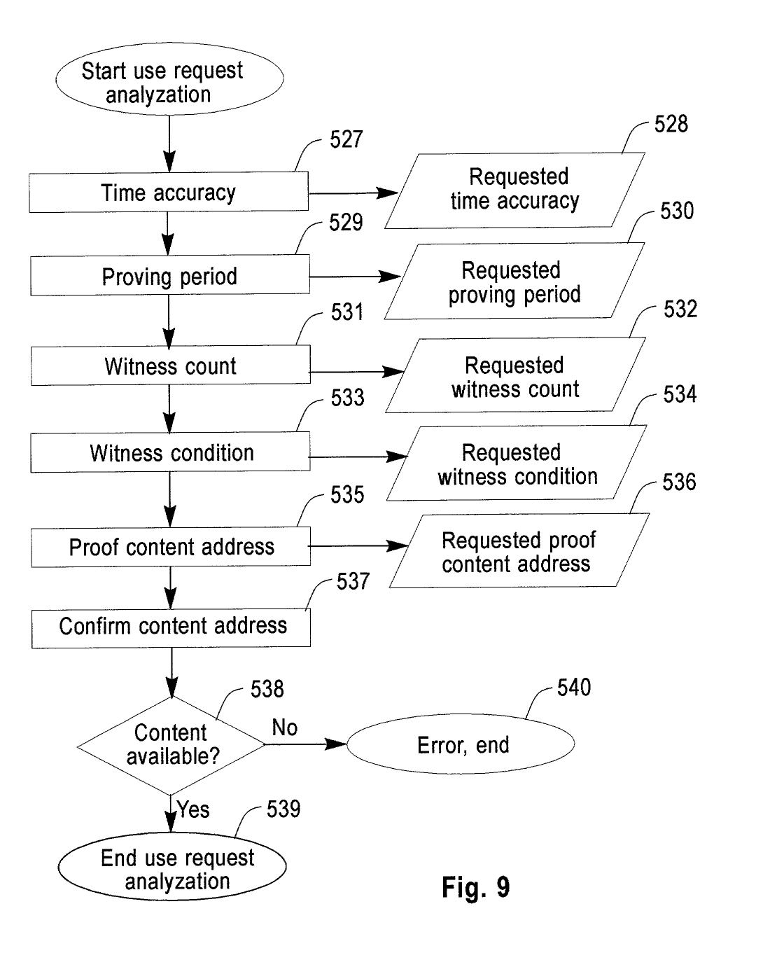

FIG. 9 is a detailed flowchart showing the user's request analyzation step (step 502). The timing accuracy included in the service request (input data) received from the user 11 is focused on (step 527), and is stored as a requested timing accuracy (step 528). Similarly, the proving period, the number of witnesses, the witness conditions and the proof content address that are entered are respectively stored as a requested proving period, the requested number of witnesses, the requested witness conditions and the requested proof content address (steps 529 to 536). Of course, additional entries can be stored as requested entries as well. To store the requested data, a check is performed to determine whether the request is appropriate. For example, when the timing accuracy is too high to be attained (e.g., 0.01 second), when the proving period is too long to be carried out (e.g., 100 years), or when the number of witnesses exceeds the number available in the registered member group, the request is judged inappropriate. An error process is performed for an inappropriate request, so that the processing can be terminated. In addition, whether the type of witness is either a human or a proxy server can be selected.

When the user's request falls within a service available range, the requested proof content address is confirmed (step 537). During this process, the service provider 10 confirms the presence of the electronic content to be proved, and attempts to obtain the content to determine the availability of the content (step 538). If the acquisition of the content is successful, the presence of the content is confirmed, and the user's request analyzation step is terminated (step 539). If the acquisition of the content fails, the error process is performed because it is highly probable that the performance of the succeeding witness process will be wasted effort. The processing is thereafter terminated (step 540).

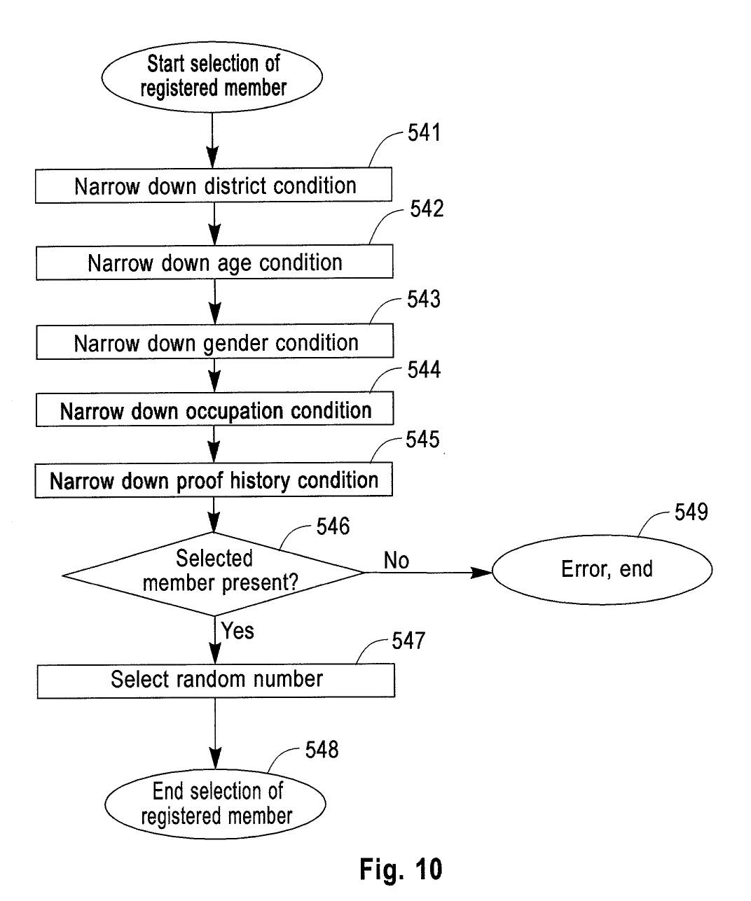

FIG. 10 is a detailed flowchart showing the registered member selection step (step 505). The registered member database 26 is employed for the selection of a registered member. The district, the age, the gender, the occupation and the proof history of the registered member are stored in the registered member database 26. At this step, the registered member is selected from the registered member database 26 in accordance with the request received from the user 11. That is, based on the district and age conditions requested by the user 11, the district condition (step 541), the age condition (step 542), the gender condition (step 543), the occupation condition (step 544), and the proof history condition (step 545) are narrowed down. The order in which these conditions are selected is arbitrary, and while not all the conditions need at all times be applied, other conditions may be added.

A check is performed to determine whether there are selected members that match the conditions for the witnesses (registered members) (whether the required number of members can be selected) (step 546). If the required number of registered members can be selected, program control advances to step 547. If the required number of registered members can not be selected, an error process is performed and the processing is thereafter terminated (step 549). After the registered members have been selected, a random number is employed to select a registered member from that group (step 547), and the selection of the registered member is terminated (step 548). Since the selection is performed under predetermined conditions in this manner, the registered member is selected at random within a requested range while the request received from the user is satisfied, so that arbitrariness in the selection of a witness is eliminated and fairness is ensured. The condition requiring the narrowing down is not requisite, and another condition may be added. In addition, the selection of the registered member need not always be performed at random; the registered members may be ranked in accordance with the system conditions established for the registered members, and may be selected in this order. Or, in order to uniformly arrange the frequency whereat registered members are selected, registered members may be chosen in the ascending order of the frequency of their prior selection.

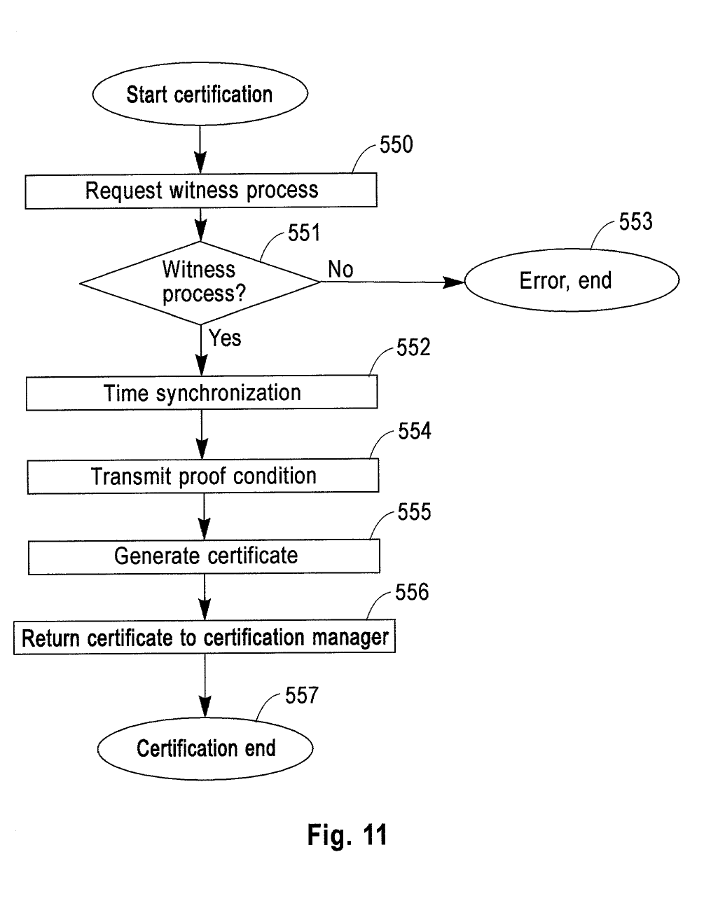

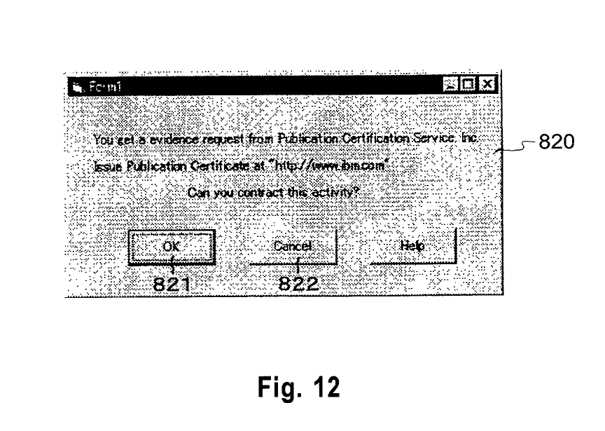

FIG. 11 is a detailed flowchart showing the proving process. First, the witness process request is issued by the service provider 10 to a witness (step 550). This request is transmitted to a witness (or a proxy server that automatically carries out the witness function) who was selected during the previous registered member selection process. The request can be issued by displaying a dialogue 820 shown in FIG. 12 on the display screen. The dialogue 820 shown in FIG. 12 is used for the confirmation of the initiation of the witness process. A message describing the request for the preparation of a certificate by the witness, and an OK button 821 and a Cancel button 822 are displayed in the dialogue 820. To accept the request, the witness clicks on the OK button 821, and to refuse the request, the witness clicks on the Cancel button 822.

Upon the receipt of the “OK” or the “Cancel” signal, the service provider 10 determines whether the witness has accepted the witness process (step 551). When it is ascertained that the witness has accepted the witness process request, program control advances to step 552. Whereas if it is ascertained the witness has not accepted the witness process request, an error process is performed and the processing is thereafter terminated (step 553).

When the system of the witness is a proxy server, a check can be performed to determine whether the witness process should be performed by using a predetermined program, and “OK” or “Cancel” data can be automatically returned to the server of the service provider.

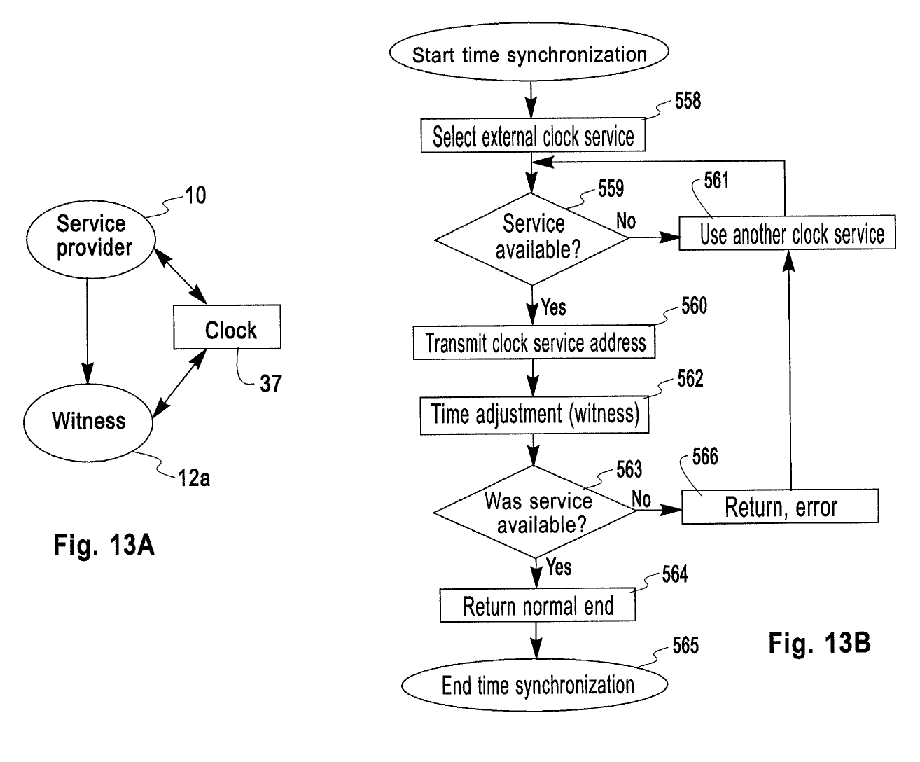

Then, the system of the service provider 10 obtains the data for clock synchronization (step 552). Clock synchronization is employed to adjust the clocks of the systems of the service provider and of the witness, and is performed by referring to an external reference clock. An example external clock service can be “www.eecis.udel.edu/_ntp/”. FIG. 13A is a block diagram showing the system of an external clock that is used for clock synchronization, and FIG. 13B is a flowchart showing the clock synchronization method. First, the system of the service provider 10 selects a clock service (step 558), and attempts to use it to determine whether the service is available (step 559). If the service is not available, an attempt is made to use another clock service (step 561). If that clock service is available, its address is transmitted to the witness (step 560). The witness then employs the clock service at the pertinent address to adjust its own clock (step 562) and a check is performed to determine whether the service was available (step 563). If the service was available, a message indicating a normal end is transmitted to the service provider (step 564). But if the service was not available, an error message is returned to the service provider 10 (step 566), and an attempt is made to use another clock service.

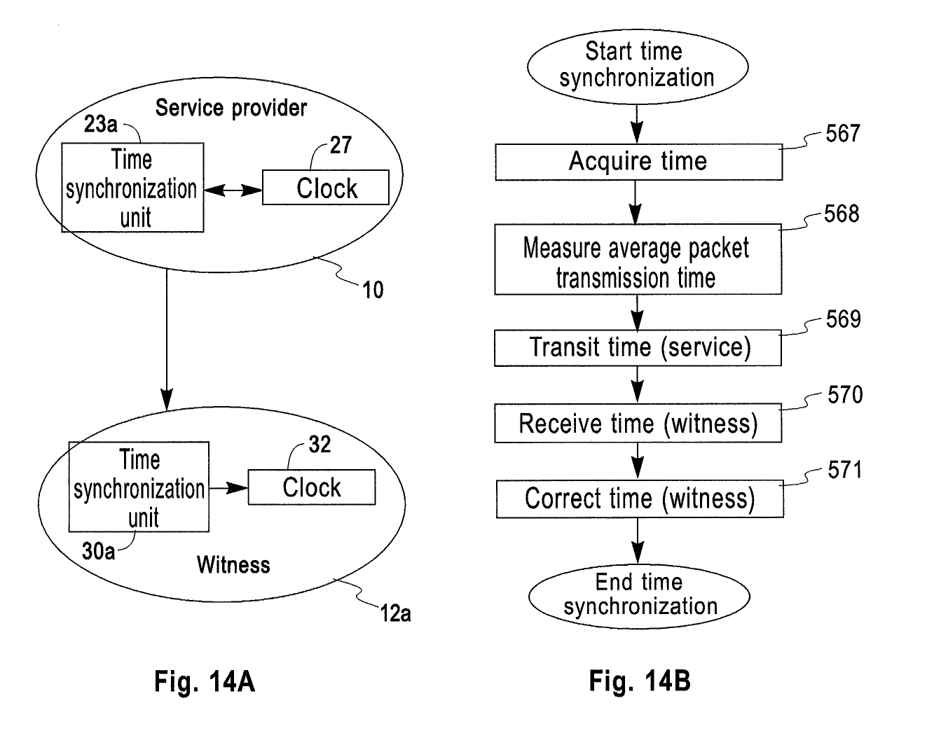

The clock synchronization method has been explained by using an external clock service; however, an internal clock may be employed for this purpose. FIG. 14A is a block diagram showing systems that employ internal clocks for clock synchronization, and FIG. 14B is a flowchart showing the clock synchronization method. First, for the systems of the service provider 10 and the witness 12a, for which time synchronization units 23a and 30a are included, the time is obtained from the clock 27 of the service provider 10 (step 567), and the time required for the transmission of an average packet is calculated (step 568). Then, the time is transmitted by the service provider 10 to the witness 12a (step 569), whereat the system receives the time transmitted by the service provider 10 (step 570). The system of the witness 12a then corrects the time for the witness 12a, while taking into account the internal clock 32, the time received from the service provider 10 and the average packet transmission time (step 571), and as in this case, the corrected time is employed for the witness 12a.

After clock synchronization has been performed, as is shown in FIG. 11, the proof condition, which includes the address of the electronic content but can also include the form for the preparation of a certificate, e.g., information concerning whether hash code should be generated using a hash function, is transmitted by the service provider 10 to the witness 12a (step 554).

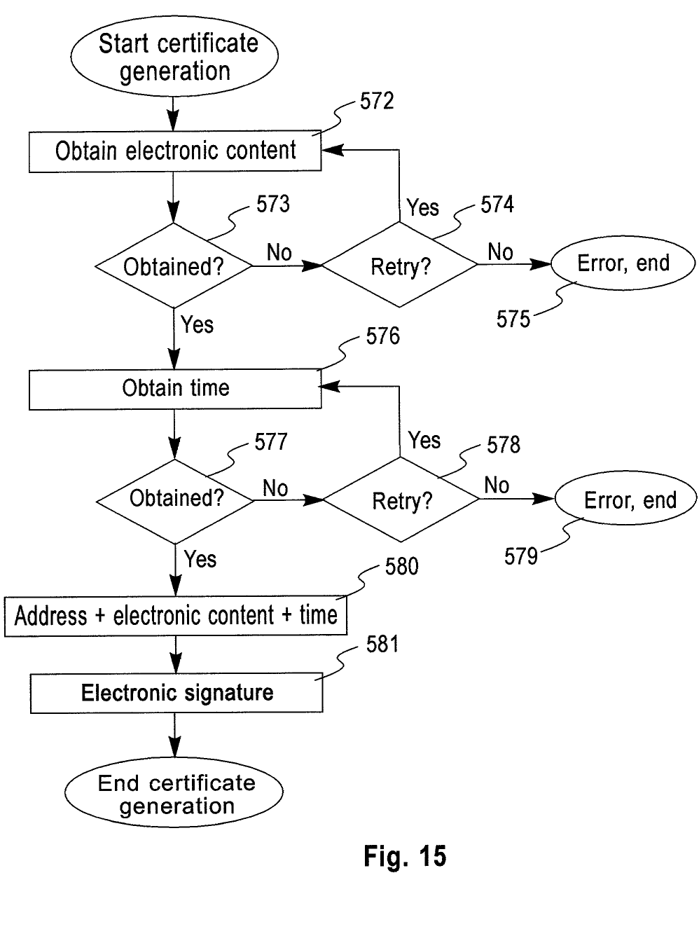

Thereafter, the witness 12a prepares a certificate (step 555). FIG. 15 is a detailed flowchart showing the certificate generation step.

First, the witness 12a accesses the content address that was transmitted at the proof condition transmission step (step 554), and attempts to obtain the electronic content 14 (step 572). For this, a check is performed to determine whether the electronic content 14 could be obtained (step 573). If the acquisition of the electronic content 14 is successful, program control advances to step 576, but if the electronic content 14 can not be obtained, another attempt is made to acquire the electronic content 14 (step 574), and program control returns to step 572. When the number of retries reaches a predetermined count, it is assumed that acquisition of the electronic content 14 has failed and an error process is performed and the processing is thereafter terminated (step 575).

After the electronic content 14 is obtained, the acquisition of the time is attempted (step 576) and a check is performed to determine whether the acquisition of the time was successful (step 577). When the time has been acquired, program control advances to step 580, but if the time can not be obtained, another attempt is made to acquire the time (step 578) and program control returns to step 576. When the number of retries reaches a predetermined count, it is assumed that the acquisition of the time has failed, and an error process is performed and the processing is thereafter terminated (step 579).

The obtained electronic content 14 and time are assembled with the content address to form the data 331 (step 580), and an electronic signature is provided for the data 331 (step 581) and the certificate preparation step is thereafter terminated.

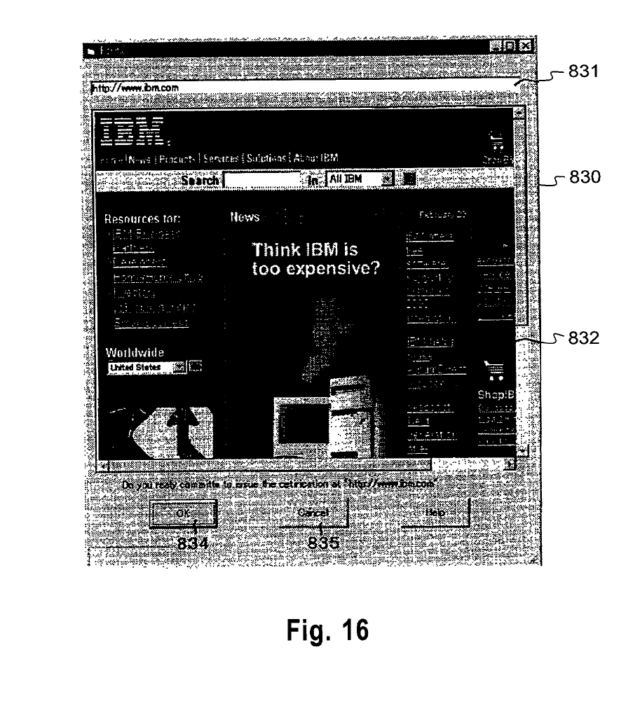

FIG. 16 is a diagram showing a display screen for a certificate preparation dialogue box at the preceding step of provision of an electronic signature. In a dialogue box 830, the address of the electronic content 14 is displayed in a field 831 and the electronic content 14 is displayed in a field 832. The results obtained by accessing the pertinent address, i.e., a message inquiring as to whether the proof can be provided for the content, and an OK button 834 and a Cancel button 835 are displayed that are used to request confirmation that the certificate has been issued. When the witness 12a clicks on the OK button 834, the certificate with an electronic signature is issued.

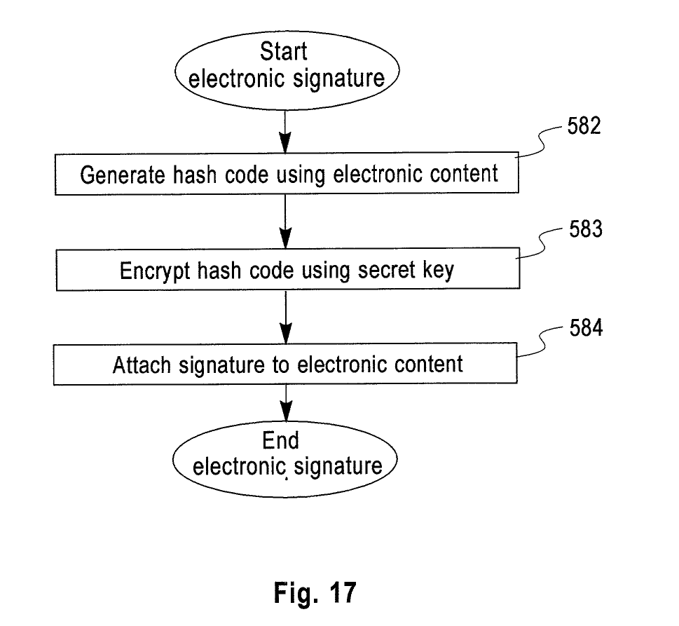

FIG. 17 is a detailed flowchart showing the electronic signature step. At step 580, data consisting of the content address, and the electronic content and the time are generated, and at step 582 hash code for this data is generated. Since the data is converted into hash code, the certificates can be distinguished between by examining the hash code, so that the determination can be easily performed. It should be noted that, as in the previous explanation of the system, the conversion of data into hash code need not always be performed. When the data satisfies a unique conversion condition, a function other than the hash function may be employed. However, when the data is not converted into hash code, or when another function is employed for code conversion, at the next step the data consisting of the content address, the electronic content and the time, or the code obtained by conversion, should be encrypted.

The hash code is encrypted by using the secret key (step 583). Since the secret key that only the witness 12a knows is employed to encrypt the hash code, alteration of the certificate is substantially impossible for anybody but the witness 12a. As will be described later, the certificate is further encrypted by the service provider by using a secret key. Since the certificate is encrypted twice, alteration of the certificate provided for the user 11 is impossible for both the witness 12a and the service provider 10. As a result, there is increased reliability that the certificate has not been altered.

The electronic content, the content address and the time are added to the hash code that is encrypted using the secret key (step 584), and the electronic signature process is terminated. And through the witness process, the certificate is generated. The public key of the public key registration service provider 10 can be attached to the certificate, so that the communication of the encrypted certificate can be safely performed.

The thus generated certificate is returned to the certification manager 23 in the service provide 10, as is shown in FIG. 11 (step 556). The proof process is thereafter terminated.

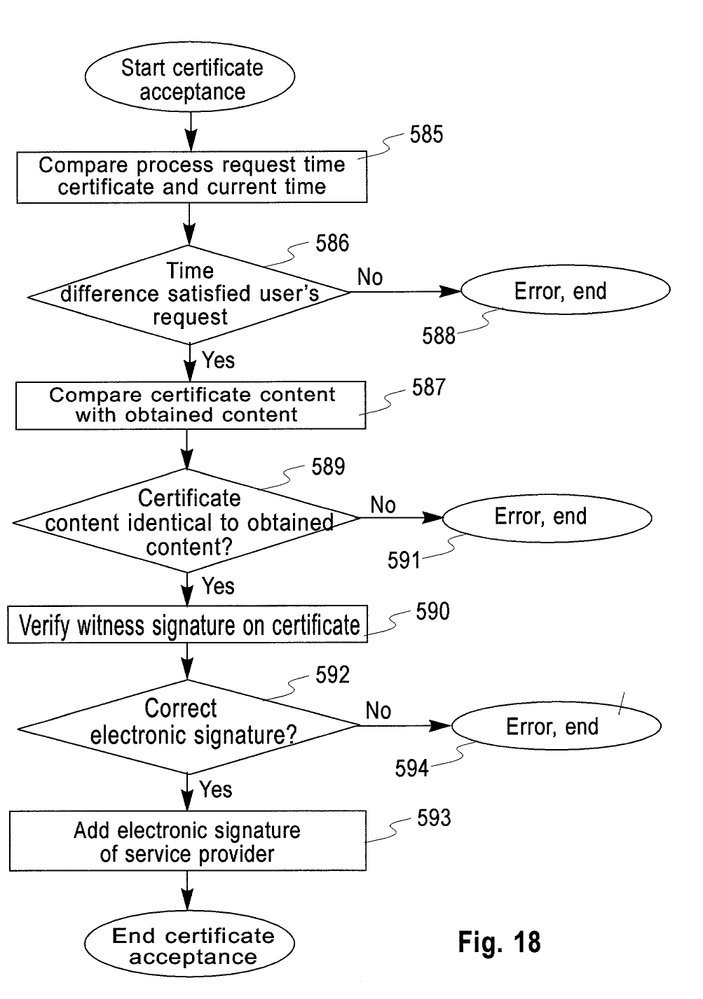

FIG. 18 is a detailed flowchart showing the certificate acceptance step. When the server of the service provider 10 receives a certificate from the witness 12a, the time for requesting the proof process, the time attached to the certificate and the current time are compared with each other (step 585), and a check is performed to determine whether the time difference satisfies the request from the user 11 (step 586). If the request is satisfied, program control advances to step 587. If the request is not satisfied, an error process is performed and the processing is thereafter terminated (step 588).

The electronic content attached to the certificate is compared with the electronic content that was previously obtained by the service provider 10 (step 587), and determines whether the electronic contents are matched (step 589). When the two electronic contents are matched, program control advances to step 590, while when the electronic contents are not matched, an error process is performed and the processing is thereafter terminated (step 591). It should be noted that hash code can be employed for determining whether the electronic content are identical. When multiple certificates are present, they can be compared with each other instead of the content previously obtained by the service provider 10.

The witness signature of the witness on the certificate is examined (step 590) to determine whether the witness signature is correct (step 592). If the signature is correct the electronic signature of the service provider 10 is additionally attached (step 593), and the certificate acceptance step is terminated. If the electronic signature on the certificate is not correct, an error process is performed and the certificate acceptance step is terminated (step 594).

Since not only the signature of the witness, but also the signature of the service provider is added to the certificate, alteration of the certificate is impossible for both the third party and the user 11, and also for the service provider and the witness. Thus, high reliability can be maintained for the certificate, and the probative force of the certificate can be increased.

A service provided by, for example, “www.moj.go.jp/PUBLIC/MINJI02/pub_minji02_{—}04.htm” is employed as the electronic signature; however, any electronic signature may be employed so long as it is ensured with a signature that the data has not been altered.

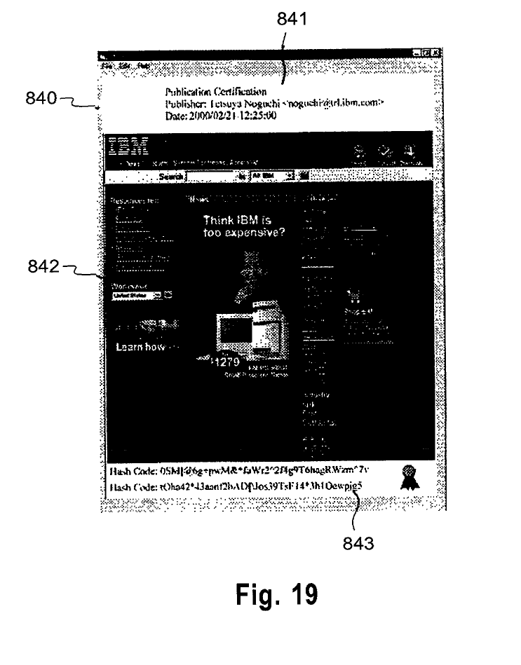

FIG. 19 is a diagram showing a display screen for the final stage of the preparation of a certificate by the service provider 10. Bibliographical data, such as the person who issued the content and the proof date, are entered in a file 841 for a frame 840, and the electronic content is displayed in a field 842. Finally, in a field 843 hash codes provided by the witness 12a and the service provider 10 are displayed.

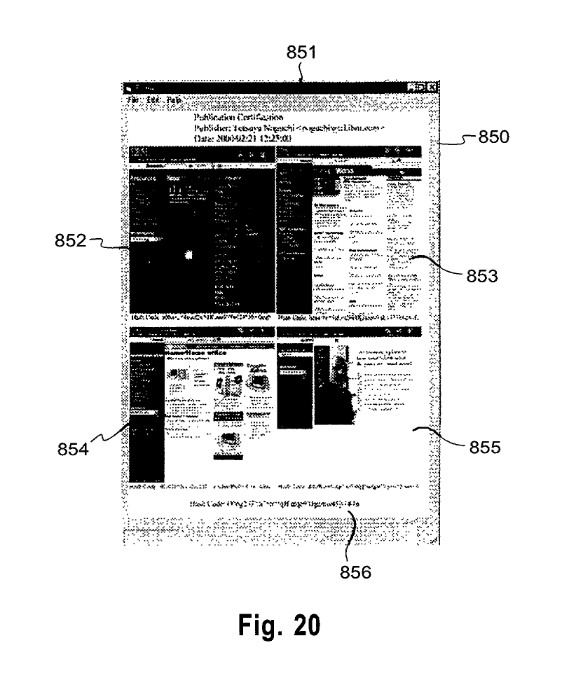

As is shown in FIG. 20, multiple electronic contents can be displayed in one certificate. In FIG. 20, bibliographical matters, such as the person who issued the electronic content and the proof date, are displayed in a field 851 of a frame 850, and multiple electronic contents are displayed in fields 852 to 855. The hash codes obtained by the witness 12a and the service provider 10 are displayed in a field 856.

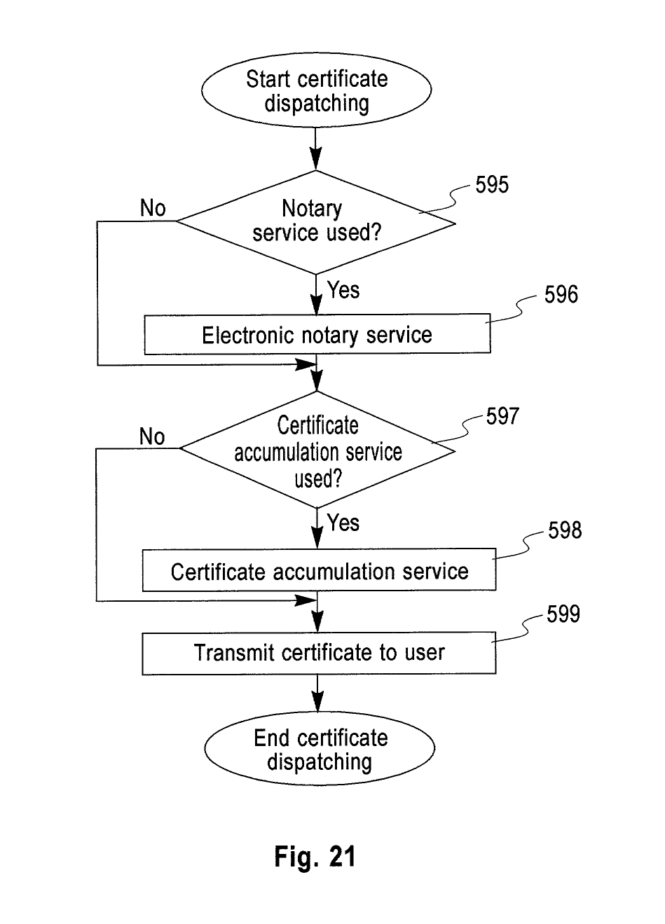

FIG. 21 is a detailed flowchart showing the certificate dispatching step. Before transmitting the certificate to the user 11, the service provider 10 determines whether a notary service is to be employed (step 595). If a notary service is employed, the notary service is received at step 596, and program control advances to step 597. If the notary service is not necessary, program control skips step 596 and jumps to step 597. A check is then performed to determine whether a certificate accumulation service is to be employed (step 597). If this service is to be employed, the certificate accumulation service is received at step 598, and program control advances to step 599. If the certificate accumulation service is not necessary, program control skips step 598 and jumps to step 599. Finally, the certificate is transmitted to the user 11 (step 599).

The proving method of this invention is completed in this manner. According to this method, the evidence for the presence of the electronic content can be collected by using the above described system. Therefore, not only the presence of the electronic content, but also the continuous presence of the same electronic content, i.e., that the electronic content has not been altered, can be proved. Further, since the witness or the proxy sever is a third party unrelated to the user, the fact is that, even strictly speaking, it can be proven that the electronic content has been opened for perusal. That is, strictly speaking, the electronic content has not been opened for perusal, even though the conventional proving institution proves the content has been opened for that institution. However, the witness or the proxy server for this invention is an unspecified third party and can be regarded as the public, and since the electronic content has been opened for perusal by the witness, it can therefore be proven that, even strictly speaking, the electronic content has been opened for perusal (made available to the public).

If the proving period is extended for a long time, the identity of the electronic content can be proven for a period before and after a specific date by using the above certificate or multiple certificates, and it can also be proven that the electronic content was altered at a specific date. Specifically, the certificates are collected continuously, and when an alteration of the electronic content or the hash code attached to the certificate was found at a specific date, it can be proven that the electronic content was changed on the specific date. In other words, non-alteration before the specific date, the alteration date, and non-alteration following the specific date can be proved. Further, when alterations were made a plurality of times, the alteration dates and the period during which the identical content was maintained can be proven.

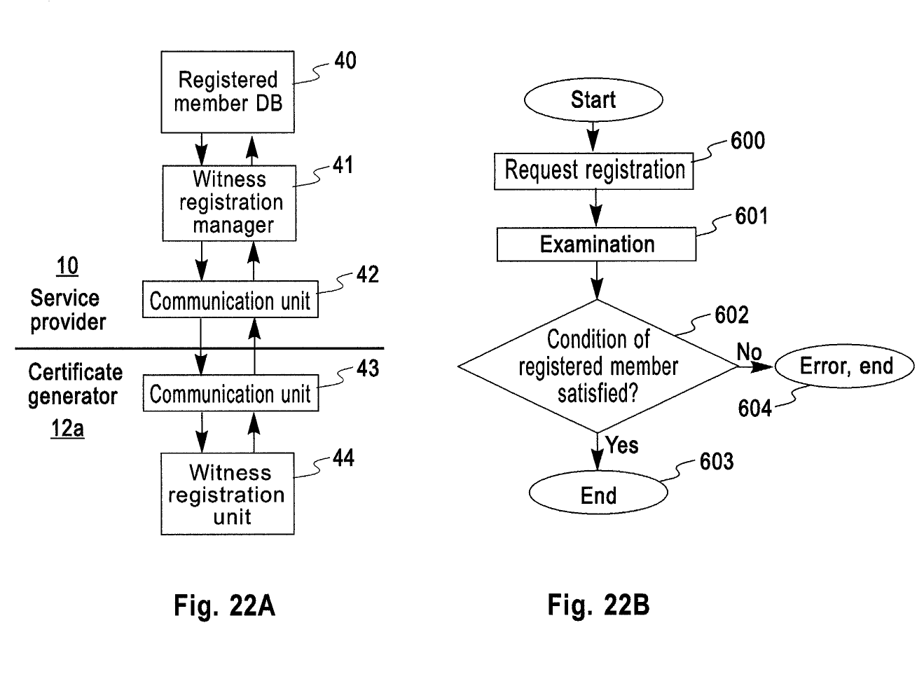

The registration of a witness can be performed as follows. FIG. 22A is a block diagram showing a witness registration system, and FIG. 22B is a flowchart showing a witness registration method. The service provider 10 and the certificate generator 12a are employed for this processing. The server of the service provider 10 comprising a registered member database 40, a witness registration manager 41 and a communication unit 42, and the certificate generator 12a including a communication unit 43 and a witness registration unit 44. First, via the communication units 43 and 42, the certificate generator 12a issues a witness registration request to the service provider 10, and the service provider 10 accepts this request (step 600). Thereafter, the witness registration manager 41 of the service provider 10 examines this witness (step 601) to determine whether the witness satisfies the registered member condition (step 602). If the witness satisfies the condition, the witness is registered in the registered member database 40, and the processing is thereafter terminated (step 603). If the witness does not satisfy the condition, an error process is performed and the processing is thereafter terminated (step 604).

### Second Embodiment

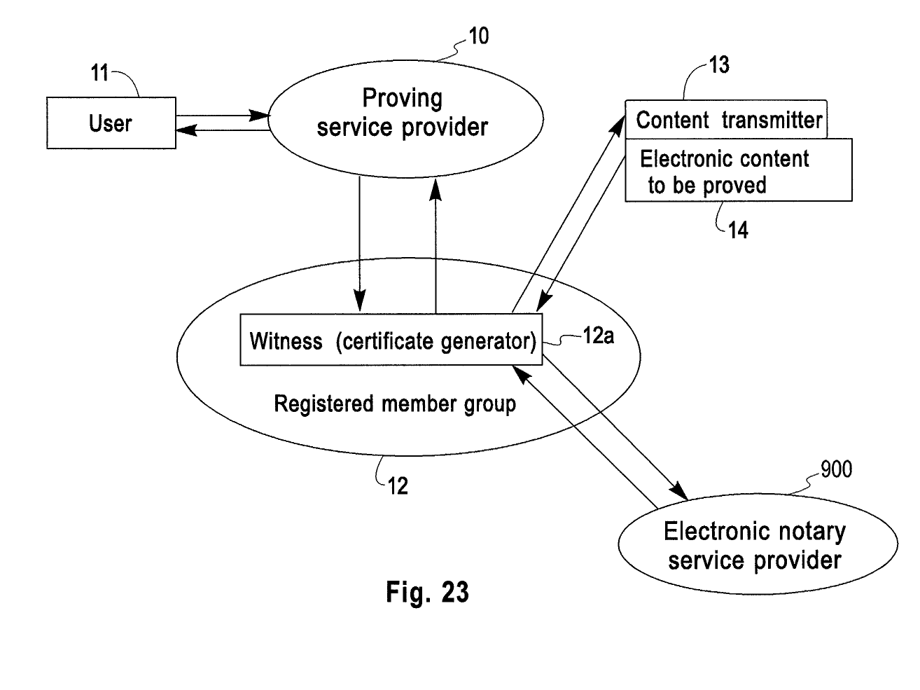

FIG. 23 is a conceptual diagram showing an example proving system according to a second embodiment of the present invention. In this embodiment, a service provider 10, a user 11, a registered member group 12, a witness or certificate generator 12a, a content transmitter 13 and an electronic content 14 are the same as those in the first embodiment, and in addition, and electronic notary service provider 900 is employed. The electronic notary service provider 900 furnishes a notary service provided, for example, by “www.surety.com”, and ensures the probative force of the certificate by using the credibility of a notary public instead of the electronic signature in the first embodiment. In the explanation that follows, a description of the components and processes of this embodiment that correspond to like elements of the first embodiment will not be given.

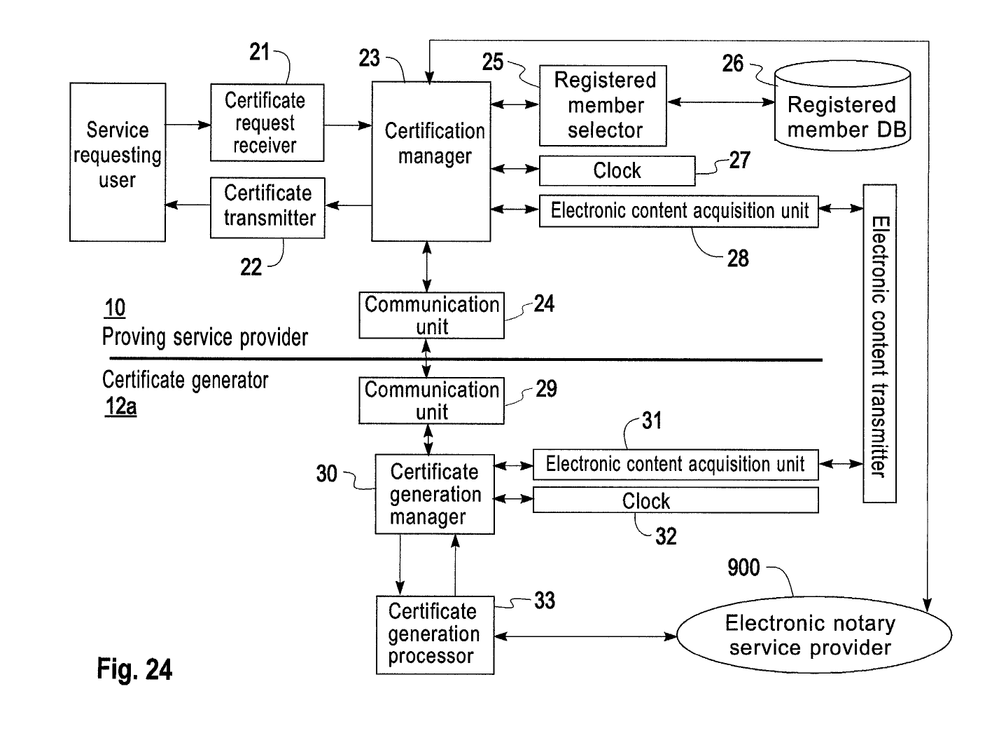

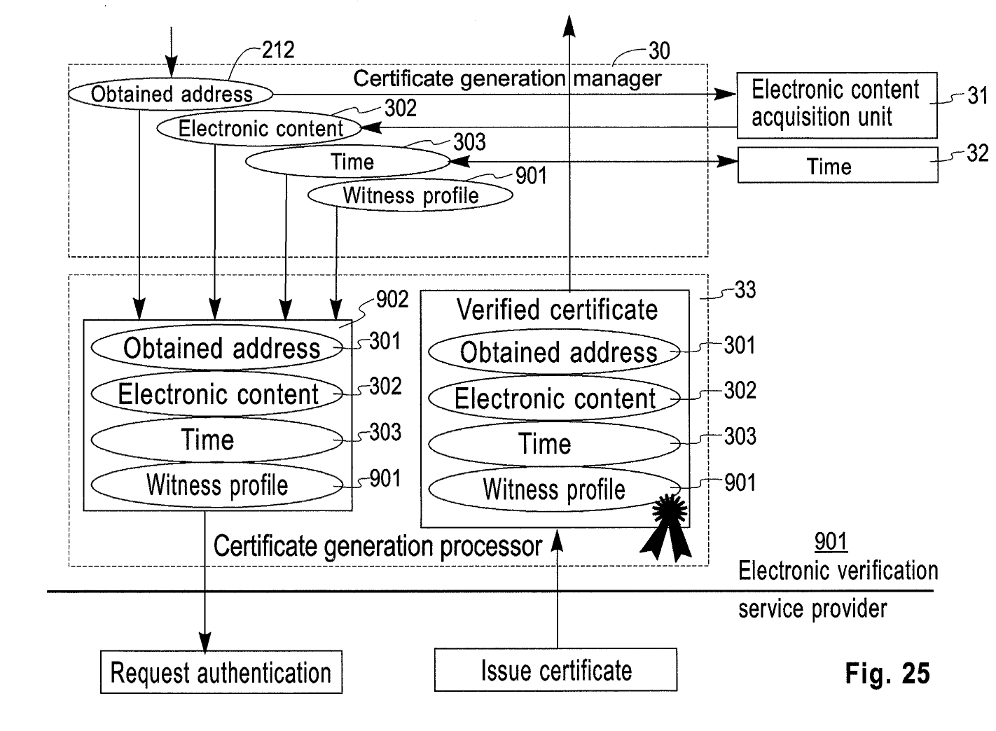

FIG. 24 is a block diagram showing an example service provider and an example certificate generator according to the system for the second embodiment. FIG. 25 is a block diagram showing an example certificate generation manager and an example certification generation processor. The service provider 10 (a certificate request receiver 21, a certificate transmitter 22, a certification manger 23, a communication unit 24, a registered member selector 25, a registered member database 26, a clock 27 and an electronic content acquisition unit 28) is the same as that in the first embodiment. And the certificate generator 12a includes a communication unit 29, a certificate generation manager 30, an electronic content acquisition unit 31, a clock 32 and a certification generation processor 33, as in the first embodiment.

In the second embodiment, the notary service provider 900 is included as a component for the proof service method and system. As is explained in the first embodiment, the certification manager 23 and the certification generation processor 33 add an electronic signature for the service provider 10 and the certificate generator 12a. In this embodiment, authentication by the notary service provider 900 is employed instead of an electronic signature. Thus, the system of this invention does not includes the electronic signature generator 34 used in the first embodiment.

As is shown in FIG. 25, the certificate generation manager 30 prepares a witness profile 901, in addition to the content address 212, the electronic content 302 and the time 303 explained in the first embodiment.

The certification generation processor 33 generates data 902 from the content address 212, the electronic content 302, the time 303 and the witness profile 901, and to request authentication, transmits the data 902 to the electronic notary service provider 900. Thereafter, the authenticated data are transmitted as a certificate 903 by the electronic notary service provider 900 to the certification generation processor 33, and the certificate 903 is then issued to the service provider 10.

According to the embodiment, even without the electronic signature of the witness or the service provider, the non-alteration of the certificate is ensured by the authentication furnished by the notary service provider 900. The alteration of the certificate 903 by the user and the third party is impossible, and the probative force of the certificate 903 can be effectively obtained.

The present invention has been explained by referring to the embodiments; however, the present invention is not limited to these embodiment, and can be variously modified without departing from the scope of the invention.

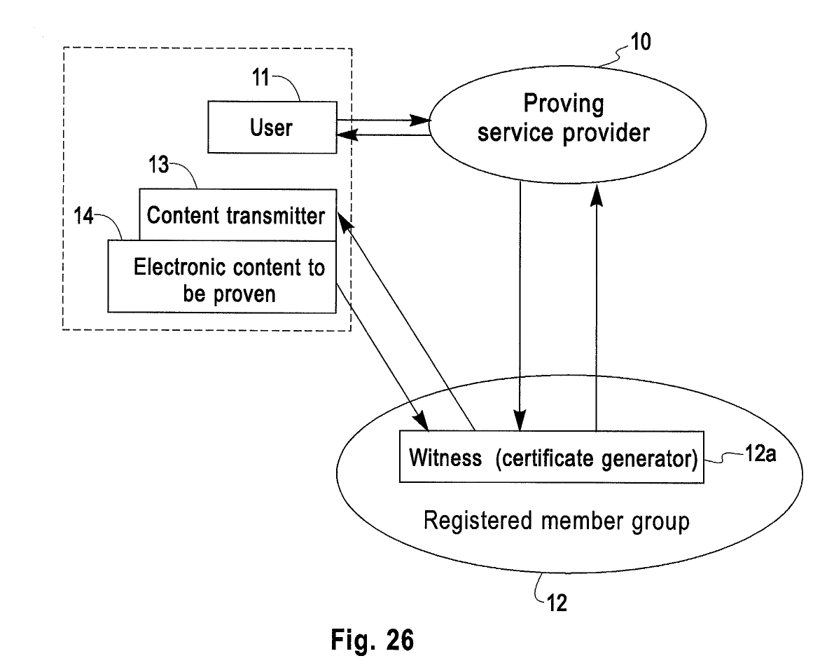

For example, as is shown in FIG. 26, the user 11 and the content transmitter 13 (electronic content 14) may be included in the same computer system.

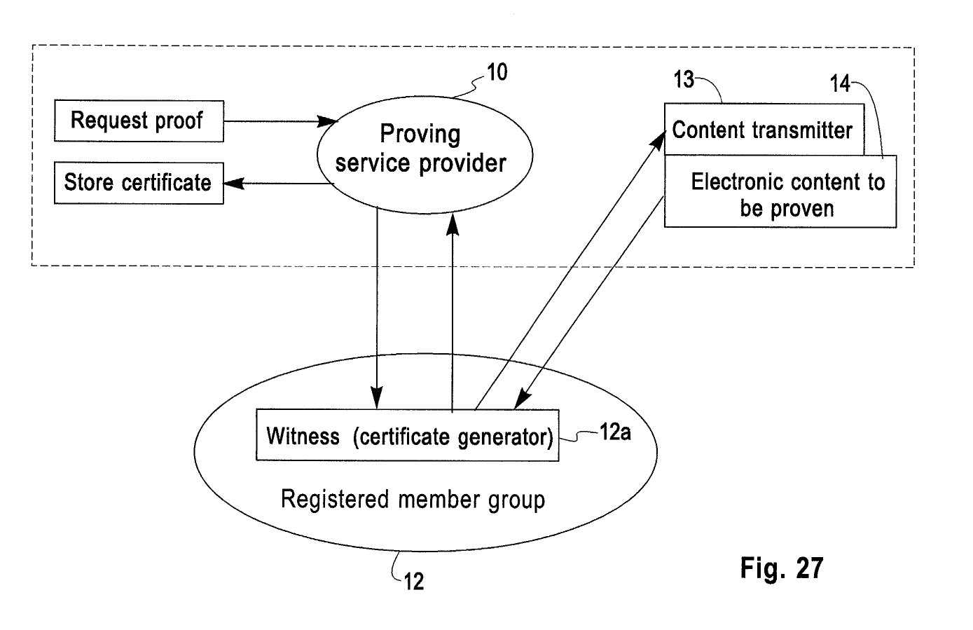

Further, as is shown in FIG. 27, the present invention may be employed to prove the electronic content 14 that is owned by the service provider 10. In this case, since the user 11 and the service provider 10 are constituted using the same computer system, the use by the means in the first embodiment of the electronic signature of the service provider to prevent the alteration of the certificate is not the preferable solution. In order to prevent the alteration of the certificate, i.e., to increase the probative force of the certificate, it is preferable that authentication by the notary service provider be obtained.

The non-alteration of the certificate is ensured by using the double electronic signatures of the service provider and the witness in the first embodiment, and by using the authentication furnished by the notary institution in the second embodiment. However, the double electronic signatures of a witness or a service provider and of a third party other than the service provider, the user and the witness may be employed. Further, the notary service may be accepted in addition to the double electronic signatures.

In conclusion, the following matters are disclosed for the configuration of the present invention.

(1) An electronic content proving method using a computer system or a computer network comprising the steps of: (a) a proof service provider transmitting a certificate generation request to a witness or a certificate generator; (b) the witness or the certificate generator obtaining electronic content upon the receipt of the certificate generation request from the service provider; and (c) generating a certificate.

(2) The electronic content proving method according to (1), wherein the certificate includes the electronic content, or data that uniquely represent the electronic content.

(3) The electronic content proving method according to (1) or (2), further comprising the step of (d) accumulating the certificate in the service provider or transmitting the certificate to a user.

(4) The electronic content proving method according to one of (1) to (3), wherein the certificate includes address information for the electronic content and time information for the proof.

(5) The electronic content proving method according to one of (1) to (4), wherein the step of generating the certificate includes a step of providing a signature for the certificate.

(6) The electronic content proving method according to (5), wherein the signature step includes a first configuration process consisting of a first signature step by the witness or the certificate generator and a second signature step by the service provider, or a second configuration process consisting of a signature step by a notary service provider.

(7) The electronic content proving method according to (5) or (6), wherein the signature is encrypted using a public key encryption method to prevent alteration by a person other than a signer.

(8) The electronic content proving method according to one of (5) to (7), wherein the signature is provided by using a secret key belonging to the witness, the certificate generator or the service provider.

(9) The electronic content proving method according to one of (2) to (8), wherein the data that uniquely represents the electronic content is a hash code.

(10) The electronic content proving method according to one of (1) to (9), wherein, before transmission of the certificate, a public key belonging to a public key authentication service provider is added to the certificate.

(11) The electronic content proving method according to one of (1) to (10), wherein a service request received from the user includes the address information for the electronic content, request information concerning an attribute of the witness, and request information concerning the proof.

(12) The electronic content proving method according to one of (1) to (11), wherein in accordance with a request from the user, the certificate generation request is transmitted to the witness or to the certificate generator on one or multiple dates, or is transmitted continuously during one or multiple specific periods.

(13) The electronic content proving method according to one of (1) to (12), wherein the witness or the certificate generator includes either a first configuration that is selected at random, a second configuration that is selected from a set of witnesses or certificate generators that satisfy a request received from the user, or a third configuration that is selected at random from a set of witnesses or certificate generators that satisfy a request received from the user.

(14) The electronic content proving method according to one of (1) to (13), wherein synchronization of time is effected between the service provider and the witness or the certificate generator.

(15) The electronic content proving method according to (14), wherein the time synchronization is effected by employing a method that uses either an external clock service or a method for employing an average packet transmission time to correct the internal clocks of the service provider and the witness or the certificate generator.

(16) A proving system for a service provider that proves oneness for perusal and non-alteration of an electronic content using a computer system or a computer network comprising: means for transmitting a certificate generation request to a witness or a certificate generator; means for obtaining electronic content upon the receipt of the certificate generation request from the service provider; and means for generating a certificate.

(17) The proving system according to (16), wherein the certificate includes the electronic content, or data that uniquely represent the electronic content.

(18) The proving system according to (16) or (17), further comprising: means for accumulating the certificate in a computer system of the service provider or means for transmitting the certificate to a user.

(19) The proving system according to one of (16) to (18), wherein the certificate includes address information for the electronic content and time information for the proof.

(20) The proving system according to one of (16) to (19), wherein the means for generating the certificate includes means for providing a signature for the certificate.

(21) The proving system according to (20), wherein the signature means includes a first configuration consisting of first signature means by the witness or the certificate generator and second signature means by the service provider, or a second configuration consisting of signature means by a notary service provider.

(22) The proving system according to (20) or (21), wherein encryption means using a public key encryption method is employed for the signature means to prevent alteration by a person other than a signer.

(23) The proving system according to one of (16) to (22), wherein the signature is provided by using a secret key belonging to the witness, the certificate generator or the service provider.

(24) A proving system for a service provider that proves openness for perusal or non-alteration of an electronic content using a computer system or a computer network, comprising: means for accepting and for analyzing a service request received from a user; means for selecting a witness or a certificate generator from a registered member group in which witnesses or certificate generators are registered; means for transmitting a certificate generation request to the witness or the certificate generator that is selected; means for accepting a certificate from the witness or from the certificate generator; and means for transmitting the certificate to the user.

(25) The proving system according to (24), wherein the means for accepting the certificate includes means for providing an electronic signature for the certificate.

(26) The proving system according to (25), wherein the electronic signature is means for encrypting the certificate using a secret key belonging to the service provider.

(27) The proving system according to one of (24) to (26), wherein the service request includes a condition concerning the witness; and wherein a first configuration that includes means for selecting a group of witnesses satisfying the condition concerning the witness, or a second configuration including means for selecting the witness or the certificate generator at random is provided as the means for selecting the witness or the certificate generator.

(28) The proving system according to one of (24) to (27), wherein the service request includes a date or a period for the proof, and wherein the means for transmitting the certificate generation request includes means for continuously transmitting the certificate generation request for the date or during the period.

(29) A system for a witness or a certificate generator that proves openness for perusal or non-alteration of an electronic content using a computer system or a computer network, comprising: means for accepting a certificate generation request from a user; means for accessing an address of an electronic content included in the certificate generation request, and obtaining the electronic content; means for generating a certificate including the electronic content, or code that uniquely represents the electronic content; and means for transmitting the certificate to the service provider.

(30) The system according to (29), wherein the means for generating the certificate includes means for providing an electronic signature for the certificate.

(31) The system according to (30), wherein the electronic signature is means for encrypting the certificate using a secret key belonging to the witness or the certificate generator.

(32) The system according to one of (29) to (31), wherein the code that uniquely represents the electronic content is a hash code.

(33) The system according to one of (29) to (32), wherein the means for generating the certificate includes means for adding time information that is synchronized with a clock of the service provider.

(34) A storage medium for storing a program code that proves openness for perusal and non-alteration of an electronic content using a computer system or a computer network, the program code comprising: a program code for, in accordance with a service request from a user or a self service request, transmitting a certificate generation request to a witness or a certificate generator; a program code for obtaining electronic content upon the receipt of the certificate generation request from the service provider; a program code for generating a certificate that includes the electronic content, or data that uniquely represent the electronic content; and either a program code for accumulating the certificate in a computer system of the service provider or a program code for transmitting the certificate to a user.

(35) A storage medium for storing a program code that proves openness for perusal and non-alteration of an electronic content using a computer system or a computer network, the program code comprising: a program code for accepting and for analyzing a service request received from a user; a program code for selecting a witness or a certificate generator from a registered member group in which witnesses or certificate generators are registered; a program code for transmitting a certificate generation request to the witness or the certificate generator that is selected; a program code for accepting a certificate from the witness or from the certificate generator; and a program code for transmitting the certificate to the user.

(36) A storage medium for storing a program code that proves openness for perusal and non-alteration of an electronic content using a computer system or a computer network, the program code comprising: a program code for accepting a certificate generation request from a service provider; a program code for accessing an address of an electronic content included in the certificate generation request, and obtaining the electronic content; a program code for generating a certificate including the electronic content, or code that uniquely represents the electronic content; and a program code for transmitting the certificate to the service provider.

The following effects are obtained by the present invention: Means can be provided for testifying to the openness for perusal of the electronic content that is available on a network. Further, means is provided for testifying that electronic content available on a network has not been altered. Furthermore, the probative force needed to demonstrate the openness for perusal or the lack of alteration of electronic content can be increased.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An electronic content proving method using a computer system or a computer network comprising the steps of:
(a) a proof service provider transmitting a certificate generation request to a witness or a certificate generator;
(b) said witness or said certificate generator obtaining electronic content upon the receipt of said certificate generation request from said service provider; and
(c) generating a certificate.

2. The electronic content proving method according to claim 1, wherein said certificate includes said electronic content, or data that uniquely represent said electronic content.

3. The electronic content proving method according to claim 1, further comprising the step of
(d) accumulating said certificate in said service provider or transmitting said certificate to a user.

4. The electronic content proving method according to claim 1, wherein said certificate includes address information for said electronic content and time information for said proof.

5. The electronic content proving method according to claim 1, wherein said step of generating said certificate includes a step of providing a signature for said certificate; and wherein said signature step includes a first configuration process consisting of a first signature step by said witness or said certificate generator and a second signature step by said service provider, or a second configuration process consisting of a signature step by a notary service provider.

6. The electronic content proving method according to claim 5, wherein said signature is encrypted using a public key encryption method to prevent alteration by a person other than a signer.

7. The electronic content proving method according to claim 2, wherein said data that uniquely represents said electronic content is a hash code.

8. The electronic content proving method according to claim 1, wherein in accordance with a request from said user, said certificate generation request is transmitted to said witness or to said certificate generator on one or multiple dates, or is transmitted continuously during one or multiple specific periods.

9. The electronic content proving method according to claim 1, wherein synchronization of time is effected between said service provider and said witness or said certificate generator.

10. A proving system for a service provider that proves oneness for perusal and non-alteration of an electronic content using a computer system or a computer network comprising:
means for transmitting a certificate generation request to a witness or a certificate generator;
means for obtaining electronic content upon the receipt of said certificate generation request from said service provider; and
means for generating a certificate.

11. The proving system according to claim 10, wherein said certificate includes said electronic content, or data that uniquely represent said electronic content.

12. The proving system according to claim 10, further comprising means for accumulating said certificate in a computer system of said service provider or means for transmitting said certificate to a user.

13. The proving system according to claim 10, wherein said certificate includes address information for said electronic content and time information for said proof.

14. The proving system according to claim 10, wherein said means for generating said certificate includes means for providing a signature for said certificate; wherein said signature means includes a first configuration consisting of first signature means by said witness or said certificate generator and second signature means by said service provider, or a second configuration consisting of signature means by a notary service provider.

15. The proving system according to claim 14, wherein encryption means using a public key encryption method is employed for said signature means to prevent alteration by a person other than a signer.

16. A proving system for a service provider that proves openness for perusal or non-alteration of an electronic content using a computer system or a computer network, comprising:
means for accepting and for analyzing a service request received from a user;
means for selecting a witness or a certificate generator from a registered member group in which witnesses or certificate generators are registered;
means for transmitting a certificate generation request to said witness or said certificate generator that is selected;
means for accepting a certificate from said witness or from said certificate generator; and
means for transmitting said certificate to said user.

17. The proving system according to claim 16, wherein said means for accepting said certificate includes means for providing an electronic signature for said certificate.

18. A system for a witness or a certificate generator that proves openness for perusal or non-alteration of an electronic content using a computer system or a computer network, comprising:
means for accepting a certificate generation request from a user;
means for accessing an address of an electronic content included in said certificate generation request, and obtaining said electronic content;
means for generating a certificate including said electronic content, or code that uniquely represents said electronic content; and
means for transmitting said certificate to said service provider.

19. The system according to claim 18, wherein said means for generating said certificate includes means for providing an electronic signature for said certificate.

20. A storage medium for storing a program code that proves openness for perusal and non-alteration of an electronic content using a computer system or a computer network, said program code comprising:
a program code for, in accordance with a service request from a user or a self service request, transmitting a certificate generation request to a witness or a certificate generator;
a program code for obtaining electronic content upon the receipt of said certificate generation request from said service provider;
a program code for generating a certificate that includes said electronic content, or data that uniquely represent said electronic content; and
either a program code for accumulating said certificate in a computer system of said service provider or a program code for transmitting said certificate to a user.

21. An article of manufacture comprising a computer usable medium having computer readable program code means embodied therein for causing an electronic content proving method, the computer readable program code means in said article of manufacture comprising computer readable program code means for causing a computer to effect the steps of claim 1.

22. A computer program product comprising a computer usable medium having computer readable program code means embodied therein for causing a proving system, the computer readable program code means in said computer program product comprising computer readable program code means for causing a computer to effect the system of claim 10.

23. A computer program product comprising a computer usable medium having computer readable program code means embodied therein for causing a proving system, the computer readable program code means in said computer program product comprising computer readable program code means for causing a computer to effect the system of claim 16.

24. A computer program product comprising a computer usable medium having computer readable program code means embodied therein for causing proof of openness for perusal or non-alteration of an electronic content, the computer readable program code means in said computer program product comprising computer readable program code means for causing a computer to effect the system of claim 18.
